(19) United States
(12) Patent Application Publication
(10) Pub. No.: US 2021/0172045 A1
(43) Pub. Date: Jun. 10, 2021

(54) HEAT-TREATMENT TRAY MEMBER AND HEAT-TREATMENT STACKED STRUCTURE

(71) Applicant: NIKKO KINZOKU CO., LTD., Tochigi (JP)

(72) Inventor: Etsuo INOUE, Tochigi (JP)

(21) Appl. No.: 16/973,409

(22) PCT Filed: Aug. 21, 2019
(86) PCT No.: PCT/JP2019/032662

§ 371 Date: Dec. 8, 2020

(30) Foreign Application Priority Data
Aug. 21, 2018 (JP) 2018-154911

(51) Int. Cl. C23C 8/20; C21D 9/32; C21D 1/06

(52) U.S. Cl. CPC C23C 8/20; C21D 1/06; C21D 9/32

(57) ABSTRACT

A heat-treatment tray member comprises a tray, and a plurality of part receivers detachably mounted onto the tray. The tray includes a base part provided with a plurality of mounting parts capable of mounting the plurality of part receivers in predetermined positions, and the base part and corner support columns are constituted by a carbon composite material, or a steel material or a nickel alloy material. The corner support columns are provided to corners of the base part to layer a plurality of the trays, and one or two or more center support columns are preferably provided at or near a center of the base part.

### FIELD OF THE INVENTION

The present invention relates to a heat-treatment tray member and a heat-treatment stacked structure. More specifically, the present invention relates to a heat-treatment tray member that, even when repeatedly loaded into a heat treating furnace with parts placed thereon in order to heat-treat the parts, suppresses the occurrence of deforming and cracking, allowing use for an extended period of time, and a heat-treatment stacked structure obtained by stacking the same.

### BACKGROUND ART

Carburizing treatment is known as a surface hardening treatment for metal parts. Carburizing treatment is a treatment in which carbon monoxide (CO) gas generated from a carburizing agent and a steel material are brought into contact at a high temperature, thereby introducing and diffusing the carbon into the metal parts to form a surface layer (carburized layer). In particular, for metal parts composed of a low carbon steel or the like having a low carbon content, only the surface layer hardens when quenching and tempering are performed after the carburizing treatment. As a result, the obtained metal product is constituted by a surface layer having wear resistance and a core rich in toughness.

In a carburizing treatment, members (carburizing furnace members) such as trays and grids for placing metal parts, which are materials to be treated, are used. The carburizing furnace members are exposed to a carburizing gas in the carburizing furnace at 800 to 1000° C. for an extended period of time. Further, the carburizing furnace members are repeatedly used, and thus are repeatedly exposed to the carburizing gas at high temperatures. Furthermore, the carburizing furnace is, in general, repeatedly heated and cooled, and thus the carburizing furnace members are placed in extremely severe temperature environments.

Therefore, an austenitic stainless steel or a heat-resistant cast steel excellent in high-temperature strength and high-temperature oxidation resistance is generally used for the carburizing furnace members. However, even if constituted by these steel materials, the carburizing furnace members tend to crack, deform, and the like due to repeated carburizing treatments and have short service lives. For example, FIG. 22 illustrates a carburizing furnace tray member 100 currently used. This carburizing furnace tray member 100 is an integral structure member having a complex structural form including a base part 111 having a quadrilateral shape, a plurality of part receivers 120 having a complex shape and arranged on the base part 111, corner support columns 112 provided to each corner of the base part 111, and a center support column 129 provided near a center of the base part 111.

The cracking, deforming, and the like of the carburizing furnace members mainly occur due to two causes. The first cause is that the carburizing treatment is repeatedly performed, thickly forming a hard and brittle carburized layer containing chromium carbide or cementite on the steel material constituting the carburizing furnace members. A carburizing furnace member with a thick carburized layer formed is likely to deform or crack due to expansion and contraction stresses associated with heating and cooling. A deformed or cracked carburizing furnace member may eventually break and become unusable.

The second cause is that the carburizing treatment is further repeatedly performed, growing the chromium carbide or the cementite over the entire carburized layer formed thickly on the carburizing furnace members, and expanding a volume of the carburized layer. The overall shape of each of the carburizing furnace members is greatly deformed due to the expansion of the volume of the carburized layer. Then, a largely deformed carburizing furnace member becomes difficult to use and, if an attempt is made to remedy the deforming, the carburized layer, being fragile, may break.

In response to such problems, it has been conventionally proposed to manufacture the carburizing furnace tray member using an alloy having improved heat resistance and carburization resistance. For example, in Patent Document 1, there is proposed a heat-resistant alloy having excellent high-temperature strength and corrosion resistance, and having excellent carburization resistance and coking resistance even in a pyrolysis environment in which carburizing and oxidation are repeated. In Patent Document 2, there is proposed a calorizing treatment for the purpose of providing a member or jig that can be stably used for an extended period of time in a gas carburizing furnace under a severe thermal shock environment. This calorizing treatment improves the carburization resistance of the member or the jig subjected to the calorizing treatment, is stable with almost no carburizing even when used for an extended period of time in a gas carburizing furnace in a severe environment, and thus can significantly extend the service life of the member or the jig. Further, this applicant, in Patent Document 3, has proposed a technique capable of imparting excellent carburization resistance at low cost to an iron alloy base material constituting a carburizing furnace member (a member such as a tray or a grid) used in a carburizing furnace.

In Patent Document 4, there is proposed use of a C/C composite, which is a carbon-based composite material, instead of stainless steel or a heat-resistant cast steel as the material of a jig for heat treatment used in a carburizing or a carbonitriding treatment, or the like. It is said that, with such material changes, the jig for heat treatment is not affected by the carburizing or the nitriding, has excellent high-temperature strength, has excellent durability to withstand thermal shock during rapid heating and quenching, and does not thermally deform, making it possible to decrease a heat capacity thereof on the basis of weight saving. In Patent Document 5, it is said that the tray on which the parts to be treated are placed is formed of a carbon-based composite material (C/C composite), thereby preventing carburizing of the tray and extending the service life thereof. Furthermore, it is said that a spacer plate made of a carburizing-retardant material is interposed between the tray formed of the carbon-based composite material and the parts to be treated, and thus the carbon component contained in the carbon-based composite material does not adversely affect the parts to be treated.

### PRIOR ART DOCUMENTS

### Patent Documents

Patent Document 1: Japanese Laid-Open Patent Application No. H05-033092

Patent Document 2: Japanese Laid-Open Patent Application No. H10-168555

Patent Document 3: Japanese Patent No. 5469274

Patent Document 4: Japanese Laid-Open Patent Application No. 2001-123219

Patent Document 5: Japanese Laid-Open Patent Application No. 2004-107705

### SUMMARY OF THE INVENTION

### Problems to be Solved by the Invention

Nevertheless, the techniques of Patent Document 1 and Patent Document 2 use a high-cost nickel-based heat-resistant alloy, or apply a calorizing treatment using a special treating agent, a container, and the like, significantly increasing the manufacturing cost of the carburizing furnace tray member. The technique of Patent Document 3 is a treatment method capable of imparting excellent carburization resistance to the carburizing furnace tray member at low cost, but requires the ability to use the tray member for an extended period of time and requires further added value and cost reduction.

It is said that, in the technique of Patent Document 4, a jig for heat treatment such as a tray is fabricated using a C/C composite, thereby making it possible to improve durability and realize a prolonged service life. However, the technique only requires the placement of many parts to be heat-treated on the tray to efficiently carry out heat treatment, and there is no mention of quality in relation to a carburization. In Patent Document 5, it is said that the spacer plate made of a carburizing-retardant material is interposed between the tray formed of the carbon-based composite material and the parts to be treated, thereby keeping the carbon component contained in the carbon-based composite material from adversely affecting the parts to be treated. However, because the heat-treated parts are randomly placed on the spacer plate constituted by a carburizing-retardant material, the heat-treated parts may come into contact with each other and carburizing may be insufficient at contacting portions thereof.

Particularly in recent years, along with the demand for prolonging the service life of jigs for heat treatment, there has been a demand for heat-treating a large number of parts to be heat-treated at once, even if the shapes are complex. This makes it necessary to precisely machine part receivers having a complex shape, such as illustrated in FIG. 22, at a narrow pitch. Furthermore, there has also been a demand for heat-treating many types of parts to be heat-treated together. Nevertheless, even if the part receivers are precisely machined at a narrow pitch, when the part receivers gradually deform due to heat treatment, the precision can no longer be ensured, making use no longer possible.

The present invention has been made to solve the above-described problems, and an object thereof is to provide a heat-treatment tray member that, even when repeatedly loaded into a heat treating furnace with parts placed thereon to heat-treat the parts, suppresses the occurrence of deforming and cracking, allowing use for an extended period of time, and further enables uniform and sufficient carburizing treatment of the parts to be heat-treated, and a heat-treatment stacked structure obtained by stacking the heat-treatment tray members.

### Means for Solving the Problems

(1) A heat-treatment tray member according to the present invention is a member repeatedly loaded into a heat treating furnace along with parts to be heat-treated, comprising a tray, and a plurality of part receivers detachably mounted onto the tray. The tray includes a base part provided with a plurality of mounting parts capable of mounting the plurality of part receivers in predetermined positions, the base part is constituted by a carbon composite material, and the plurality of part receivers are constituted by a steel material or a nickel alloy material.

According to this invention, (a) the tray is a member separate from and not a structure integral with the part receivers as in the conventional technique, making it possible to simplify the structure of the base part, achieve a reduction in man-hours compared to the conventional technique, and decrease manufacturing costs. (b) The base part constituting the tray, which is a member separate from the part receivers, is fabricated using a carbon composite material that has heat resistance and does not readily thermally deform, and thus, even when the tray is repeatedly loaded into a heat treating furnace for an extended period of time, deforming, cracking, and the like are less likely to occur, allowing repeated use for an extended period of time. (c) The part receivers, which are members separate from the tray, can be detachably mounted onto the plurality of mounting parts of the tray, and thus, even if complex in shape or not insusceptible to deforming over an extended period of time due to heat treatment, can be immediately replaced with other spare parts. In particular, when the part receivers serving as separate members are preferably fabricated by a lost wax process, it is possible to obtain high accuracy at low cost and, even if the shapes are complex, heat-treat a large number of parts to be heat-treated in one type or many types at once.

(2) In the heat-treatment tray member according to the present invention, each of the plurality of mounting parts has a frame structure constituted by a frame and a space surrounded by the frame, and the frame structure is selected from a circle, an ellipse, a triangle, a quadrangle, a honeycomb shape, and shapes similar thereto. According to this invention, the mounting parts for mounting the part receivers have a simple frame structure, making it possible to easily mount the part receivers. As a result, the part receivers can be mounted onto the base part, which has heat resistance and does not readily thermally deform, and the parts to be heat-treated can be heat-treated without concern regarding deforming and cracking of a tray as in the conventional technique.
(3) In the heat-treatment tray member according to the present invention, the base part is provided with a corner support column at each corner thereof, and the corner support column is constituted by a carbon composite material. According to this invention, when a plurality of trays are used upon layering, the structure of the trays can be simplified by the base part and the corner support columns. Further, the corner support column, similar to the base part, is also fabricated using a carbon composite material that has heat resistance and does not readily thermally deform, and thus, even when a plurality of the trays used upon layering are repeatedly loaded into the heat treating furnace for an extended period of time, deforming, cracking, and the like are less likely to occur, allowing repeated use for an extended period of time.
(4) In the heat-treatment tray member according to the present invention, the base part is provided with one or two or more center support columns at or near a center thereof, and the one or two or more center support columns are constituted by a carbon composite material. According to this invention, one or two or more center support columns are provided, making it possible to more stably support the trays when a plurality of the trays are used upon layering. Further, the center support column, similar to the base part, is also fabricated using a carbon composite material that has heat resistance and does not readily thermally deform, and thus, even when a plurality of the trays used upon layering are repeatedly loaded into the heat treating furnace for an extended period of time, deforming, cracking, and the like are less likely to occur, allowing repeated use for an extended period of time.
(5) In the heat-treatment tray member according to the present invention, the base part is provided with a corner support column at each corner thereof, and the corner support column is constituted by a steel material or a nickel alloy material. According to this invention, when a plurality of the trays are used upon layering, the structure of the trays can be simplified by the base part and the corner support columns. Further, the corner support column, while fabricated using a steel material or a nickel alloy material, has a straight rod-like simple shape, and thus does not readily buckle and, even when a plurality of the trays used upon layering are repeatedly loaded into the heat treating furnace for an extended period of time, deforming, cracking, and the like are less likely to occur, although not to the same extent as in a carbon composite material, allowing repeated use for an extended period of time.
(6) In the heat-treatment tray member according to the present invention, the base part is provided with one or two or more center support columns at or near a center thereof, and the one or two or more center support columns are constituted by a steel material or a nickel alloy material. According to this invention, one or two or more center support columns are provided, making it possible to more stably support the trays when a plurality of the trays are used upon layering. Further, the center support column, similar to the corner support column, while fabricated using a steel material or a nickel alloy material, has a straight rod-like simple shape, and thus does not readily buckle and, even when a plurality of the trays used upon layering are repeatedly loaded into the heat treating furnace for an extended period of time, deforming, cracking, and the like are less likely to occur, although not to the same extent as in a carbon composite material, allowing repeated use for an extended period of time.
(7) In the heat-treatment tray member according to the present invention, when a plurality of the trays are to be stacked, one of the following is selected: (a) the corner support columns and the one or two or more center support columns each include, at a lower portion thereof, a lower engaging part that engages with an upper portion of another support column and couples to the base part via a coupling member, and, at an upper portion thereof, an upper engaging part that engages with a lower portion of another support column and couples to another tray to be stacked in an upper stage via another coupling member, (b) the corner support columns and the one or two or more center support columns each include, at a lower portion thereof, a lower engaging part that engages with an upper portion of another support column and couples to the base part via a coupling member, and, at an upper portion thereof, an upper engaging part that directly engages with a lower portion of another support column and couples to another tray to be stacked in an upper stage without a coupling member, (c) the corner support columns and the one or two or more center support columns each include, at a lower portion thereof, a lower engaging part that directly engages with an upper portion of another support column and couples to the base part without a coupling member, and, at an upper portion thereof, an upper engaging part that engages with a lower portion of another support column and couples to another tray to be stacked in an upper stage via another coupling member, and (d) the corner support columns and the one or two or more center support columns each include, at a lower portion thereof, a lower engaging part that directly engages with an upper portion of another support column and couples to the base part without a coupling member, and, at an upper portion thereof, an upper engaging part that directly engages with a lower portion of another support column and couples to another tray to be stacked in an upper stage without a coupling member.

It should be noted that, in the present application, when not differentiated, the corner support column and the center support column are simply referred to as “support column.” According to this invention, it is possible to couple the support columns (corner support columns and center support columns) to the base part via a coupling member or directly without a coupling member, and to another tray as well. It should be noted that the support columns (corner support columns and center support columns) are coupled to the corners of the base part or to support column attaching holes provided at or near a center of the base part.

(8) In the heat-treatment tray member according to the present invention, the corner support columns and the one or two or more center support columns each include an upper engaging part that engages with an engaging part of a lower portion of another support column in an upper stage and couples to another tray in an upper stage, and a lower engaging part that engages with an engaging part of an upper portion of another support column in a lower stage and couples to another tray in a lower stage, and the upper engaging part is formed with a shoulder part that places and engages with another tray in an upper stage.
(9) In the heat-treatment tray member according to the present invention, the coupling member includes an upper engaging part that engages with an engaging part of a support column lower portion and couples the support column and the tray, and a lower engaging part that engages with an engaging part of another support column upper portion in a lower stage and couples the support column and another tray in a lower stage.
(10) In the heat-treatment tray member according to the present invention, when a plurality of the trays are to be stacked, a lower engaging part that couples the base part and a lower portion of the support column in a first stage is coupled by the coupling member described in (9) above, and an engaging part that couples to another tray to be stacked in a second stage is coupled by the upper engaging part of a support column in the first stage and the lower engaging part of a support column in the second stage described in (8) above. Another tray to be stacked in a third or subsequent stage has a structure similar to that in the second stage.
(11) In the heat-treatment tray member according to the present invention, each of the plurality of part receivers includes a pedestal that detachably comes into contact with the tray, a locking part that is provided to the pedestal and holds the pedestal on the tray, and a part receiving section that extends above the pedestal or a part receiving section that is located on the pedestal. According to this invention, an engaging part is provided to a pedestal that comes into contact with the tray, making it possible to hold the detachable part receivers on the respective mounting parts of the tray. As a result, even when the part receivers can be prepared as spares and parts to be heat-treated having other shapes are to be simultaneously heat-treated, a plurality of types of the part receivers to be mounted onto the tray can be simultaneously mounted.
(12) In the heat-treatment tray member according to the present invention, the part receiving section includes a frame-shaped receiving section and a support column part.
(13) In the heat-treatment tray member according to the present invention, when a plurality of the trays are to be stacked, each of the plurality of part receivers includes an upper engaging part that engages with a lower engaging part of another part receiver provided to a tray in an upper stage and couples the part receiver and the tray in the upper stage, and a lower engaging part that engages with an upper engaging part of another part receiver provided to a tray in a lower stage and couples the part receiver and the tray in the lower stage, and the upper engaging part includes a shoulder part that places and supports the other tray in the upper stage. According to this invention, such a part receiver is adopted, making it possible to stack a plurality of the heat-treatment tray members without use of a coupling member.
(14) In the heat-treatment tray member according to the present invention, when a plurality of the trays are to be stacked, each of the plurality of part receivers is selected from the following: (a) a part receiver that includes, in an upper portion thereof, a shoulder part that places and holds a tray in an upper stage without engaging with a lower engaging part of another part receiver provided to the tray in the upper stage, and, in a lower portion thereof, a hole part that may or may not engage with an upper portion of another part receiver provided to a tray in a lower stage, (b) a part receiver that includes, in an upper portion thereof, a projection that engages with a lower engaging part of another part receiver provided to a tray in an upper stage and, in a lower portion thereof, a hole part that engages with a projection of another part receiver provided to a tray in a lower stage, (c) a part receiver that includes a shoulder part that only places and holds a tray in an upper stage without engaging with a lower engaging part of another part receiver provided to the tray in the upper stage, and a locking part that locks an upper engaging part of another part receiver provided to a tray in a lower stage, and (d) a part receiver that includes only an upper engaging part that engages with a lower engaging part of another part receiver provided to a tray in an upper stage and does not include a locking part that locks an upper engaging part of another part receiver provided to a tray in a lower stage. According to this invention, by using any of these (a) to (d) in combination, it is possible to stack a plurality of the heat-treatment tray members without use of a coupling member.
(15) In the heat-treatment tray member according to the present invention, the plurality of part receivers are fabricated by a lost wax process. According to this invention, the part receivers, which are members separate from the tray, can be detachably mounted onto the tray, and thus, even if complex in shape or not insusceptible to deforming over an extended period of time due to heat treatment, can be immediately replaced with other spare parts. In particular, the part receivers being separate members and fabricated by the lost wax process are high in accuracy and low in cost and, even if the shapes are complex, a large number of parts to be heat-treated in one type or many types can be heat-treated at once.
(16) A heat-treatment stacked structure according to the present invention is a heat-treatment stacked structure obtained by stacking a plurality of heat-treatment tray members and repeatedly loaded into a heat treating furnace along with parts to be heat-treated. The heat-treatment tray member in a first stage is a base member constituted by a steel material or a nickel alloy material, and the heat-treatment tray member in a second or subsequent stage is the heat-treatment tray member described in any one of (11) to (15) above.
(17) A heat-treatment stacked structure according to the present invention is a heat-treatment stacked structure obtained by stacking a plurality of heat-treatment tray members and repeatedly loaded into a heat treating furnace along with parts to be heat-treated. The heat-treatment tray member in a first stage includes a base part, a corner support column, a center support column, and a plurality of part receivers, the corner support column and the center support column being integrally constituted with the base part by a steel material or a nickel alloy material, and the part receivers being detachably mounted onto the base part, and the heat-treatment tray member in a second or subsequent stage is the heat-treatment tray member described in any one of (11) to (15) above.
(18) A heat-treatment stacked structure according to the present invention is a heat-treatment stacked structure obtained by stacking a plurality of heat-treatment tray members and repeatedly loaded into a heat treating furnace along with parts to be heat-treated. The heat-treatment tray member in a first stage includes a base part, a corner support column, a center support column, and a part receiver, the corner support column and the center support column being integrally constituted with the base part and the part receiver by a steel material or a nickel alloy material, and the heat-treatment tray member in a second or subsequent stage is the heat-treatment tray member described in any one of (11) to (15) above.

### Effect of the Invention

According to the present invention, it is possible to provide a heat-treatment tray member that, even when repeatedly loaded into a heat treating furnace with parts placed thereon to heat-treat the parts, suppresses the occurrence of deforming and cracking, allowing use for an extended period of time, and further enables sufficient and uniform carburizing treatment of the parts to be heat-treated.

### BRIEF DESCRIPTION OF THE DRAWINGS

FIG. 1 is a perspective structural drawing illustrating an example of a heat-treatment tray member according to the present invention.

FIG. 2 is an example of a tray member constituting the heat-treatment tray member illustrated in FIG. 1.

FIGS. 3A and 3B are two examples of part receivers constituting the heat-treatment tray member illustrated in FIG. 1.

FIG. 4 is a form view of when the tray member illustrated in FIG. 2 is layered to obtain a multi-stage structure.

FIG. 5 is a plan view of the tray member illustrated in FIG. 2.

FIG. 6 is a sectional view illustrating an example of a multi-stage structure obtained by layering the tray members.

FIG. 7 is a detailed sectional view of a coupling means of the multi-layer structure illustrated in FIG. 6.

FIG. 8 is a sectional view illustrating another example of a multi-stage structure obtained by layering the tray members.

FIGS. 9A and 9B are detailed sectional views of the coupling means of the multi-layer structure illustrated in FIG. 8.

FIG. 10 is a detailed sectional view of the coupling member used in the multi-layer structure illustrated in FIG. 8.

FIGS. 11A and 11B is another example of the part receiver mounted to the heat-treatment tray member.

FIG. 12 is a perspective view illustrating an example of a tray on which the part receivers in FIGS. 11A and 11B are placed.

FIG. 13 is a perspective view illustrating the heat-treatment tray member with the part receivers in FIGS. 11A and 11B placed on the tray in FIG. 12.

FIG. 14 is a perspective view illustrating a heat-treatment stacked structure obtained by stacking the heat-treatment tray members illustrated in FIG. 13.

FIGS. 15A and 15B are other examples of the part receiver mounted to the heat-treatment tray member.

FIGS. 16A and 16B are other examples of the part receiver mounted to the heat-treatment tray member.

FIG. 17 is a perspective view illustrating an example of the tray on which the part receivers in FIGS. 15A and 15B and the part receivers in FIGS. 16A and 16B are placed.

FIG. 18 is a perspective view illustrating the heat-treatment tray member with the part receivers in FIGS. 15A and 15B and the part receivers in FIGS. 16A and 16B placed on the tray in FIG. 17.

FIG. 19 is a perspective view illustrating a heat-treatment stacked structure obtained by stacking the heat-treatment tray members illustrated in FIG. 18.

FIG. 20 is a perspective view illustrating an example of a base member used in the heat-treatment stacked structure in FIG. 18 and FIG. 19.

FIG. 21 is a perspective view illustrating an example of a tray member obtained by integrating a base part and support columns.

FIG. 22 is a perspective structural drawing illustrating an example of a conventional heat-treatment tray member.

### EMBODIMENTS OF THE INVENTION

Hereinafter, a heat-treatment tray member and a heat-treatment stacked structure according to the present invention will be described with reference to the drawings. It should be noted that the present invention is not limited to the embodiments described below.

### [Heat-Treatment Tray Member of First Embodiment]

A heat-treatment tray member 10 in a first embodiment, as illustrated in FIG. 1 to FIG. 4, is a composite member (also referred to as a hybrid member) constituted by a tray 1 and a plurality of part receivers 2 detachably mounted onto the tray 1, and is a member repeatedly loaded into a heat treating furnace along with parts to be heat-treated. Then, the tray 1 includes a base part 11 provided with a plurality of mounting parts 13 capable of mounting the part receivers 2 in predetermined positions, the base part 11 is constituted by a carbon composite material, and the part receivers 2 are constituted by a steel material or a nickel (Ni) alloy material.

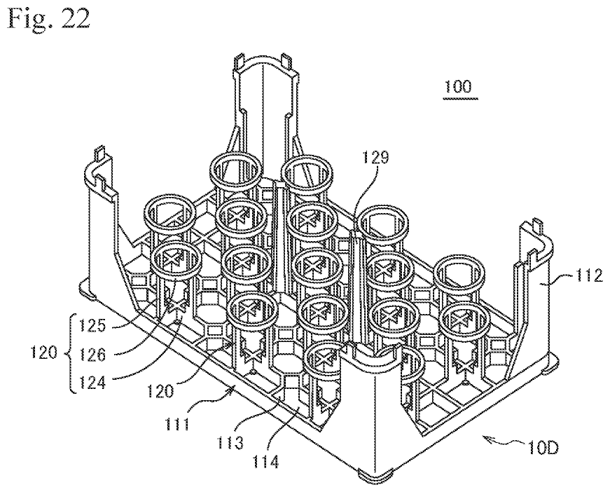

In this heat-treatment tray member 10, (a) the tray 1 is a member separate from and not a structure integral with the part receivers 2 as in the conventional example illustrated in FIG. 22, making it possible to simplify the structure of the base part 11. Furthermore, this makes it possible to achieve a reduction in man-hours and decrease manufacturing costs compared to the conventional technique. (b) The base part 11 constituting the tray 1, which is a member separate from the part receivers 2, is fabricated using a carbon composite material that has heat resistance and does not readily thermally deform, and thus, even when the tray 1 is repeatedly loaded into a heat treating furnace for an extended period of time, deforming, cracking, and the like are less likely to occur, allowing repeated use for an extended period of time. (c) The part receivers 2, which are members separate from the tray 1, can be detachably mounted onto the plurality of mounting parts 13 on the tray 1, and thus, even if complex in shape or not insusceptible to deforming over an extended period of time due to heat treatment, can be immediately replaced with other spare parts. In particular, when the part receivers 2 composed of separate members are preferably fabricated by a lost wax process, it is possible to obtain high accuracy at low cost and, even if the shapes are complex, heat-treat a large number of parts to be heat-treated in one type or many types (two or more types) at once.

Hereinafter, each of the components will be described.

### <Tray>

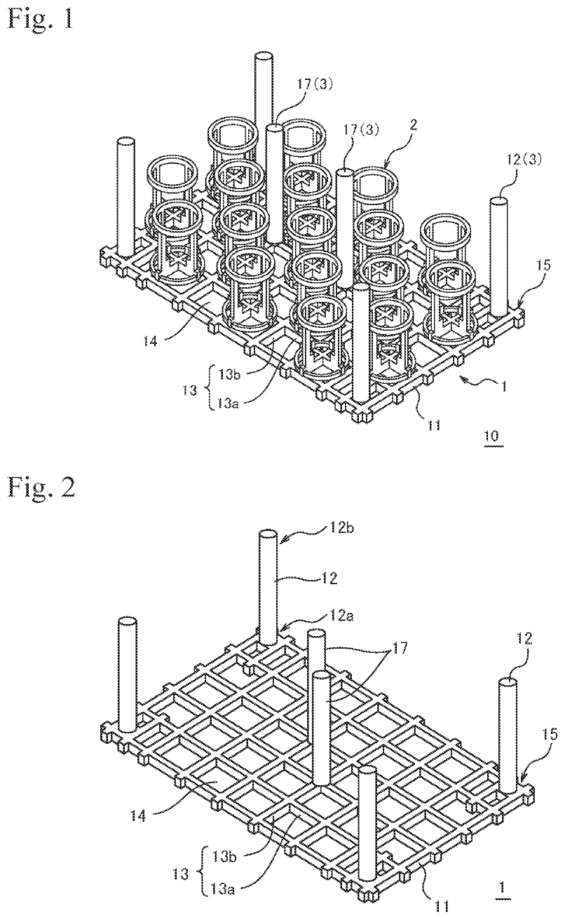

The tray 1, as illustrated in FIG. 2, is provided separately from the part receivers 2 and includes at least the base part 11. This base part 11 is formed of a carbon composite material. The base part 11 is a member including the plurality of mounting parts 13 capable of mounting the part receivers 2 described later in predetermined positions. The tray 1 is provided with a corner support column 12 and a center support column 17 as needed. The corner support column 12 and the center support column 17 are each provided at corners 15 and at or near a center of the tray 1 when one or two or more of the trays 1 are layered to obtain a multi-stage structure, and used. Desirably, the corner support column 12 and the center support column 17 are also formed of a carbon composite material. Thus, the structure of the tray can be simplified. Furthermore, the entire tray is fabricated using a carbon composite material that is heat-resistant and does not readily thermally deform. Therefore, even when a plurality of the trays used upon layering are repeatedly loaded into a heat treating furnace for an extended period of time, deforming, cracking, and the like are less likely to occur, allowing repeated use for an extended period of time.

The corner support column 12 and the center support column 17 provided to the tray 1 may be formed of a steel material or a Ni alloy material. A steel material or a Ni alloy material is inferior in heat resistance and thermal deformation compared to a carbon composite material, but is less expensive than a carbon composite material, and therefore the columns may be replaced when use is no longer possible due to thermal deforming or the like. It should be noted that, in addition to the corner support column 12 and the center support column 17, a side support column (not illustrated) may be provided to a periphery of the tray. Preferably, the side support column is also formed of a material similar to that of the corner support column 12 and the like.

The heat-treatment tray member 10 in the first embodiment will now be described using the tray 1 including the base part 11, the corner support column 12, and the center support column 17 as an example.

### (Carbon Composite Material)

A carbon composite material, compared to a metal material, has high heat resistance and is less susceptible to thermal expansion and thermal deforming. With the base part 11, the corner support column 12, and the center support column 17 fabricated using a carbon composite material, even when the tray 1 is repeatedly loaded into a heat treating furnace for an extended period of time, deforming, cracking, and the like are less likely to occur, allowing repeated use for an extended period of time. Specifically, a carbon composite material has enough heat resistance for use even at about 2200° C. Therefore, unlike the carburizing treatment, the nitriding treatment, and the like of parts to be heat-treated, there is no adverse effect due to thermal deforming or the like due to heat treating temperatures of about 950° C. to approximately 1200° C. Pricewise, a carbon composite material is expensive compared to a steel material, and thus preferably the tray 1 (base part 11, corner support column 12, center support column 17) is fabricated using a carbon composite material after simplifying structures thereof to the extent possible. A tray fabricated using a carbon composite material can be used for an extended period of time. As a result, in terms of total cost, even if the tray is fabricated using an expensive carbon composite material, the cost can be significantly reduced.

As the carbon composite material, various materials can be used. A carbon material having high strength and high elasticity and reinforced with carbon fiber is preferable. In particular, preferable examples include a carbon matrix such as graphite in which carbon fibers are combined as reinforced fibers. As the carbon fibers, those having a long fiber length are preferable to those having a short fiber length, and those having a regular arrangement in vertical and horizontal directions are preferable to those randomly arranged in the matrix without directionality. With the carbon fibers combined in the matrix in this mode, the material can be preferably utilized as a carbon composite material having high tensile strength and high elasticity for the tray 1 (base part 11, corner support column 12, center support column 17) of the present invention. It should be noted that, while not particularly limited, a bending strength is approximately 140 to 160 MPa, a tensile strength is approximately 250 MPa, a bulk specific gravity is approximately 1.6 g/cm³, a compressive strength is approximately 90 MPa, a bending elastic modulus is approximately 60 GPa, and a tensile elastic modulus is approximately 80 GPa, for example. Further, a thermal expansion coefficient is approximately 0.2 to 0.4 (//)×10⁻⁶/K and approximately 5 to 9 (⊥)×10⁻⁶/K, and a thermal conductivity is approximately 27 (//) W/m·K and approximately 4 (⊥) W⁶/m·K, but are not limited thereto. When the tray 1 is constituted by the base part 11, the corner support column 12, and the center support column 17, these may be fabricated using the same carbon composite material or using different carbon composite materials. Whether the materials are the same or different can be selected as desired in consideration of ease of manufacture, material cost, strength required for each, and the like.

Specifically, as a commercially available carbon composite material, for example, the Sigrabond series by SGL Carbon Japan Co., Ltd., the CCM190 series by Nippon Carbon Co., Ltd., or the like can be obtained as desired, and selected as desired for use. Further, a material obtained by impregnating a carbon composite material with silicon (Si) can also be selected as desired for use. Furthermore, these carbon composite materials are marketed as bolts and nuts as well, and can be used and machined. It should be noted that, while the machining method of these carbon composite materials is not particularly limited, the materials can be machined into a predetermined structural shape by machining means such as general cutting, grinding, or water jet cutting.

### (Base Part)

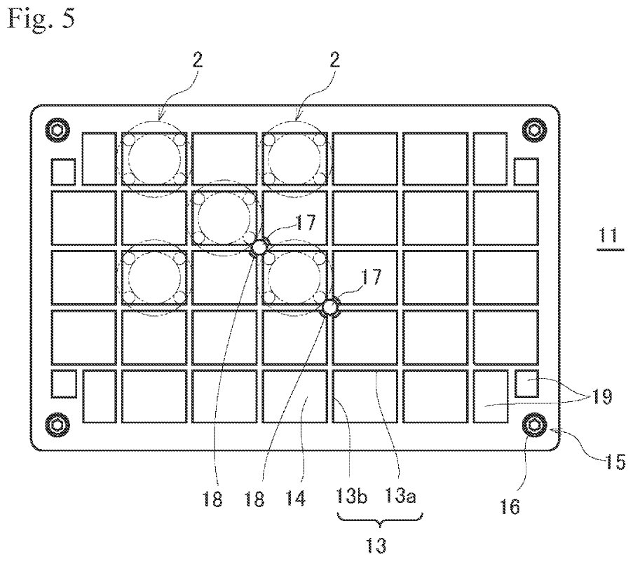

The base part 11, as illustrated in FIG. 1, FIG. 2, and FIG. 5, is a member including the plurality of mounting parts 13 capable of mounting the part receivers 2 in predetermined positions. This base part 11 is provided with the mounting parts 13, support column attaching parts (attaching holes) 16 provided to each of the corners 15 thereof, and support column attaching parts (attaching holes) 18 provided at or near the center thereof. The mounting part 13 is an area where the part receiver 2 is easily mounted. A shape of the mounting part 13 is not particularly limited, but is preferably constituted by a frame structure constituted by a frame (for example, 13a, 13b) and a space 14 surrounded by the frame (for example, 13a, 13b). A shape of the frame structure is preferably selected from a circle, an ellipse, a triangle, a quadrangle (such as a square or a rectangle), a honeycomb shape (a hexagon), or shapes similar thereto. In FIG. 1 and the like, the mounting part 13 having a rectangular frame-shape and constituted by the vertical frame 13a and the horizontal frame 13b is illustrated as a preferable example of a carbon composite material easily machined at low cost. The mounting part 13 for mounting the part receiver 2 has a simple frame structure, making it possible to easily mount the part receiver 2. As a result, the part receiver 2 can be mounted onto the base part 11, which has heat resistance and does not readily thermally deform. Furthermore, a structural form thereof is extremely simple compared to the conventional example in FIG. 22, making it possible to easily machine the carbon composite material and carry out fabrication at low cost. Moreover, the parts to be heat-treated can be heat-treated without concern regarding deforming or cracking of the tray as in the conventional technique.

The base part 11 may be prepared by obtaining a base part with the mounting parts 13 molded therein, or by obtaining a plate and subsequently machining the mounting parts 13. A thickness of the base part 11 and a size and a shape of the mounting part 13 can be designed as desired according to a usage form, heat treating conditions, a structural form of the part receiver 2, and the like. Further, in the actual heat treatment process of parts, when various base parts 11 provided with the mounting parts 13 having different sizes and shapes are prepared and made into a series, the base parts 11 and the part receivers 2 are switched out, making it possible to heat-treat various parts to be heat-treated.

It should be noted that the corners 15 of the base part 11 are each provided with the support column attaching part (attaching hole) 16 for coupling the corner support column 12 to the base part 11. Further, as illustrated in FIG. 1, when the center support column 17 is provided at or near the center of the base part as needed, the support column attaching part (attaching hole) 18 for coupling the center support column 17 to the base part 11 is provided.

### (Corner Support Column)

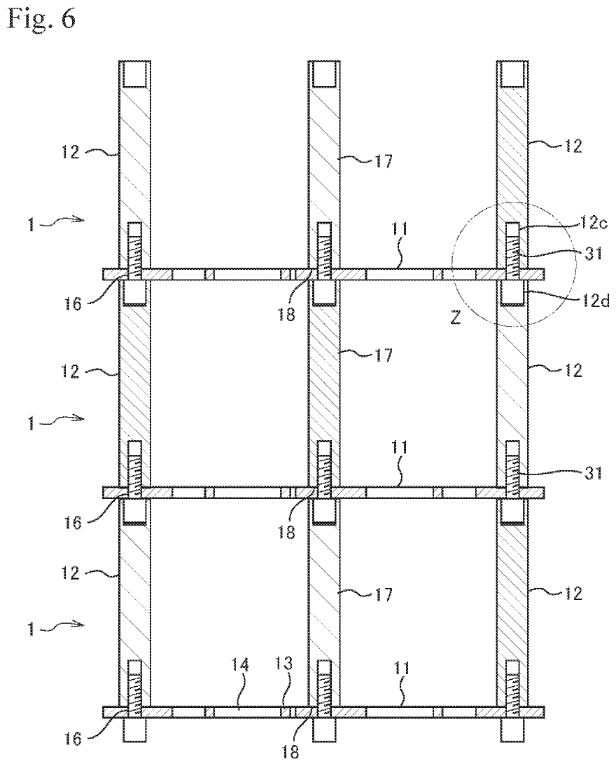

The corner support column 12, as illustrated in FIG. 1 and FIG. 2, is provided to each of the corners 15 of the base part 11, and is a member for layering a plurality of the trays 1. The corner support column 12 used is usually a carbon composite material having a round rod-shape or a square rod-shape, but may be a steel material or a Ni alloy material. As illustrated in FIG. 2 and FIG. 6, a support column lower portion 12a of the corner support column 12 includes an engaging part 12c (screw hole, for example) that engages (is screwed, for example) with a coupling member 31 (coupling screw, for example) and couples to the base part 11. A support column upper portion 12b of the corner support column 12 includes an engaging part 12d (insertion hole, for example) that engages with (inserts or places, for example) another coupling member 31 (screw head, for example) and couples to another tray 1 to be stacked in an upper stage. With such a structural form, the corner support column 12 can be coupled to the base part 11 by the coupling member 31 and coupled to another tray 1 as well. It should be noted that the coupling member 31, while a coupling screw can be preferably applied, may be any other member as long as the member exhibits a similar function.

The corner support column 12, similar to the above-described base part 11, is also formed of a carbon composite material. Therefore, a rigid structural form such as illustrated in the conventional example in FIG. 22 is not necessary, and even a simple cylindrical member or the like is sufficient. As the corner support column 12, a support column that can withstand the weight of a plurality of the layered trays 1 can be selected as desired for use. The corner support column 12 may be obtained by molding, but various sizes are available from the market as well.

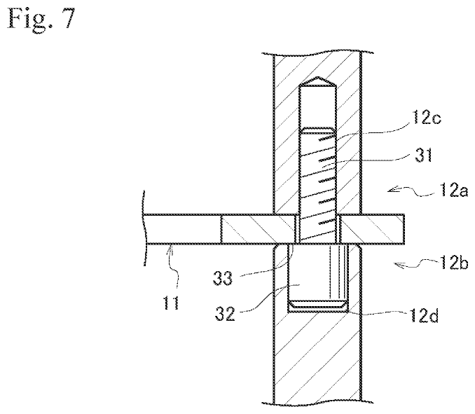

As illustrated in FIG. 7, when the coupling member 31 is a screw (referred to as a coupling screw), the engaging part 12c of the support column lower portion 12a may be a screw hole that is screwed with the coupling screw 31 and couples to the base part 11. Further, the engaging part 12d of the support column upper portion 12b may be an insertion hole for inserting a head part of the coupling screw 31 coupled to another tray. A head shape is not particularly limited, but may be such that the head part does not rotate and the engaging part 12d has a hole shape, and, for example, preferably is the same as the hole shape of the engaging part 12d (however, excluding a circular shape; a quadrangle, a hexagon, or the like). Further, dimensions and shapes of the screw hole and the insertion hole can be designed as desired in response to a screw pitch, a screw length, the head shape, and the like of the coupling screw 31 to be used, and are not particularly limited. It should be noted that, when a member other than the coupling member 31 having a screw shape is adopted as well, the member may be the engaging parts 12c, 12d corresponded to a shape and a function of the coupling member 31.

### (Center Support Column)

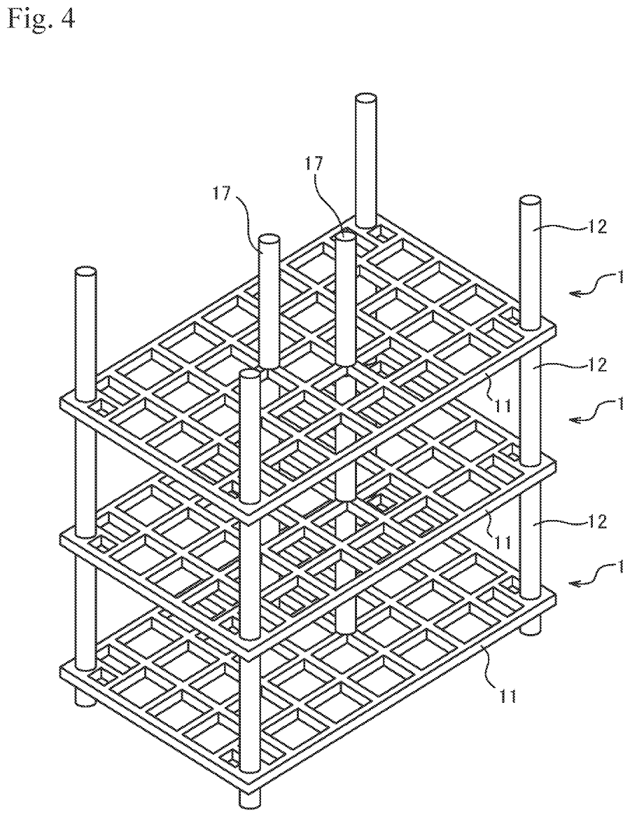

The center support column 17 is provided at or near the center of the base part 11 in a quantity of one or two or more, as needed. By providing the center support column 17, it is possible to more stably support the layered trays 1. The center support column 17 used, similar to the corner support column 12 described above, is a carbon composite material having a round rod-shape or a square rod-shape, but may be a steel material or a Ni alloy material. The quantity and installation positions of the center support columns 17, while not particularly limited, may be a quantity and positions capable of stably supporting the layered trays 1, and may be two as illustrated in FIG. 1 and the like, or three or more (not illustrated). Further, the center support columns 17 may be provided in an arrangement such as illustrated in FIG. 1, or in arrangements such as illustrated in FIG. 2, FIG. 4, and FIG. 5. Furthermore, desirably the center support column 17 have the same structural form as the engaging part 12c (screw hole) and the engaging part 12d (insertion hole) provided to the corner support column 12. Moreover, desirably the coupling member of the center support column 17 is also similar to the coupling member 31 of the corner support column 12. Thus, the center support column 17 can be made common to the corner support column 12. The base part 11 is provided with the support column attaching part (attaching hole) 18 for coupling the center support column 17. It should be noted that other features are also similar to those of the corner support column 12, and thus descriptions thereof are omitted here.

### <Coupling Means>

### (First Coupling Means)

Examples of the coupling means for stacking the trays 1 in multiple stages include a first coupling means in FIG. 6 and FIG. 7. The coupling by the first coupling means is performed between a support column 3 (corner support column 12 and center support column 17; hereinafter the same) and the coupling member 31. With regard to the support column 3, as illustrated in FIG. 6 and FIG. 7, the lower portion 12a of the support column 3 includes the engaging part 12c (engaging hole) that engages with the upper portion 12b of another support column 3 via the coupling member 31, and the upper portion 12b of the support column 3 includes the engaging part 12d (insertion hole) that engages with the lower portion 12a of another support column 3 via another coupling member 31. The coupling member 31, as illustrated in FIG. 7, includes an upper engaging part 33 (screw part) that engages with the engaging part 12c (screw hole) of the support column lower portion 12a, and a lower engaging part 32 (cylindrical part) that engages with the engaging part 12d (insertion hole) of another support column upper portion 12b in a lower stage. The tray 1 is interposed between the support column 3 and the coupling member 31 in a state in which the tray 1 is placed on a shoulder part of the lower engaging part 32 (cylindrical part) of the coupling member 31. This first coupling means stacks the trays 1 with a screw member serving as the coupling member 31, and differs from a second coupling means described later in that a coupling screw is not used.

As the coupling member 31, as illustrated in FIG. 6 and FIG. 7, a screw member (also referred to as the coupling screw 31) composed of a carbon composite material is preferably used. This coupling member 31 (coupling screw) acts to engage with (screw into) the engaging part 12c (screw hole) of the support column lower portion 12a of the corner support column 12, and couple the corner support column 12 and the tray 1. Further, the coupling member 31 (coupling screw) acts to engage with (insert into) the engaging part 12d (insertion hole) of the support column upper portion 12b of another corner support column 12 arranged in a lower stage, and engage with (insert) the corner support column 12 and another tray 1 in a lower stage. As illustrated in FIG. 6, the center support column 17 can also be coupled to the upper and lower center support columns 17 by the same coupling member 31.

Specifically, this coupling member 31 engages with the upper and lower support columns 3 and couples the two. With the upper and lower support columns 3 coupled, the base part 11 is interposed between the support columns 3 and a plurality of the trays 1 are stacked. The base part 11, as illustrated in FIG. 5, is provided with an attaching hole composed of the corner support column attaching part 16 and an attaching hole composed of the center support column attaching part 18. The coupling member 31 (coupling screw) is inserted into the attaching hole from below and screwed into the engaging part (screw hole) 12c of the support column lower portion 12a. With this screwing, the coupling member 31, the support column 3, and the base part 11 interposed therebetween are integrated as the tray member 10. The lower engaging part (cylindrical part) 32 constituting the integrated tray member 10 is inserted into the engaging part (insertion hole) 12d of the support column 3 constituting another tray member 10. The tray members 10 are stacked by the first coupling means to obtain a heat-treatment stacked structure.

A structural form of the coupling member 31, while not particularly limited, can be designed as desired according to the usage form, the heat treating conditions, the structural form of the corner support column 12, and the like. For example, in the case of the coupling member 31 (coupling screw) having a screw shape, the screw pitch, the screw length, the head shape, and the like can be designed as desired in the same way as a general metal screw. From the standpoint of machining cost, relatively simple hexagon-head bolts and square-head bolts can be preferably adopted. Further, a member other than the coupling member 31 having a screw shape may be adopted. It should be noted that, as described above, when the coupling member 31 is a screw, the head shape may be such that the head part does not rotate and the engaging part 12d has a hole shape, and preferably, for example, is the same as the hole shape of the engaging part 12d (however, excluding a circular shape; a quadrangle, a hexagon, or the like). The coupling member 31 may be composed of a carbon composite material, or a steel material or a Ni alloy material.

### (Second Coupling Means)

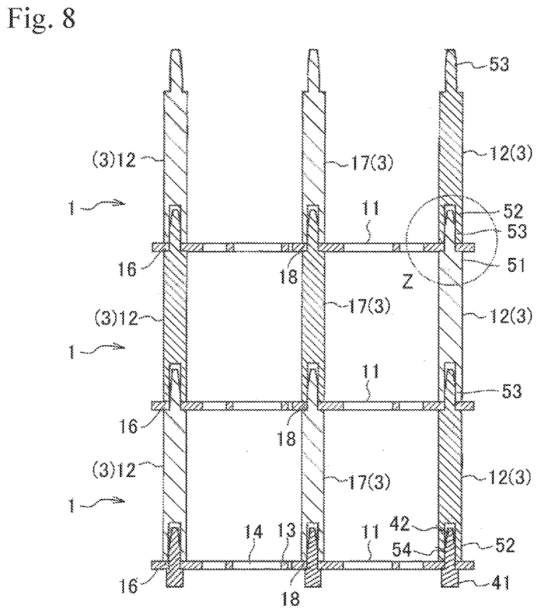

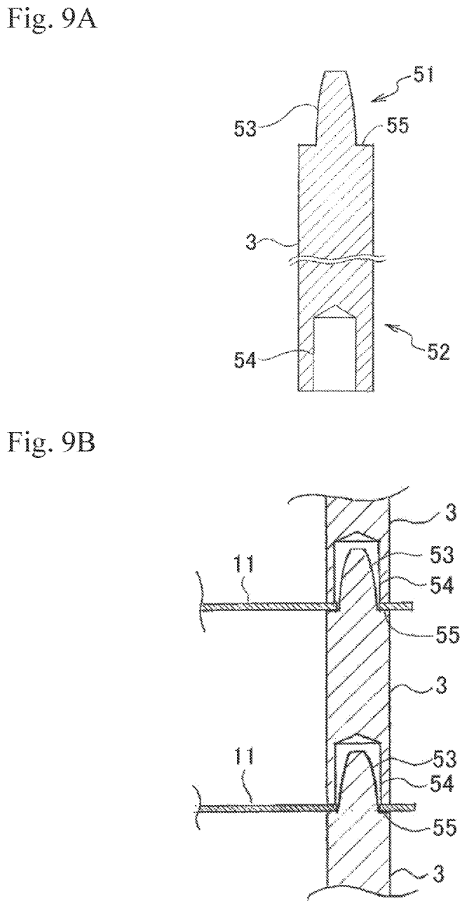

Examples of the coupling means for stacking the trays 1 in multiple stages include the second coupling means in FIG. 8 to FIG. 10. The coupling by the second coupling means is performed by engaging the support column 3, excluding a coupling member 41 used in a lowermost stage. With regard to the support column 3, as illustrated in FIG. 8, a lower portion 54 of the support column 3 includes a lower engaging part 52 that directly engages with an upper portion 53 of another support column and couples to the base part 11 without a coupling member. The upper portion 53 of the support column 3 includes an upper engaging part 51 that directly engages with the lower portion 54 of another support column 3 and couples to another tray 1 to be stacked in an upper stage without a coupling member. That is, in the second coupling means, the support column 3 including the upper engaging part 51 provided to the support column upper portion 53 and the lower engaging part 52 provided to the support column lower portion 54 is used as the coupling member. The tray 1 is interposed between the upper and lower support columns 3 in a state in which the tray 1 is placed on a shoulder part 55 of the lower engaging part 52 of the support column 3. In this respect, the second coupling means differs from the first coupling means that uses the coupling screw described above. FIG. 8 and FIG. 9 illustrate a form in which the support column 3, such as the corner support column or the center support column, acts as a coupling member, and FIG. 10 illustrates the coupling member 41 positioned at a bottom of the heat-treatment tray member 10.

In FIG. 9, the upper engaging part 51 provided to the upper portion of the support column 3 is a projection, and the lower engaging part 52 provided to the lower portion 54 of the support column 3 is an engaging hole. The projection and the engaging hole are formed in predetermined sizes, and the projection of the support column 3 positioned below acts so as to be inserted into and coupled with the engaging hole of the support column 3 positioned above. The base part 11 of the tray 1 is interposed between the projection and the engaging hole. The base part 11 is placed on the support column shoulder part (base part receiving section) 55 below and is pressed by the support column lower portion 54 above. The tray members 10 are stacked by the second coupling means to obtain a heat-treatment stacked structure.

FIG. 10 is an example of the coupling member 41 positioned in the lowermost stage. This coupling member 41 is constituted by a projection extending upward and inserted into the engaging hole of the support column lower portion 54 in the same manner as an upper engaging part 42 of the support column 3 described above, and a head part 43 positioned below and including a shoulder part 44. With this coupling member 41 in the lowermost stage as well, the projection and the head part 43 are formed in predetermined sizes, and the base part 11 of the tray 1 is interposed between the projection and the head part 43. The base part 11 is placed on the shoulder part (base part receiving section) 44 below and is pressed by the support column lower portion 54 above. Accordingly, with the second coupling means illustrated in FIG. 8 to FIG. 10, the lower engaging part 52 that couples the base part 11 and the lower portion 54 of the support column 3 in the first stage is coupled by this coupling member 41, and the engaging part that couples to another tray 1 to be stacked in the second stage is coupled by the upper engaging part 51 of the support column 3 in the first stage and the lower engaging part 52 of the support column 3 in the second stage.

Structural forms of the support column 3 and the coupling member 41 constituting the second coupling means, while not particularly limited, can be designed as desired according to the usage form, the heat treating conditions, the structural forms of the corner support column 12 and the center support column 17, and the like. For example, a clearance between the projection and the engaging hole is appropriately designed to prevent an increase in rattling. Further, the projection of the support column upper portion 53 may be designated as a male screw, and the engaging hole of the support column lower portion 54 may be designated as a female screw. As a screw structure, the screw pitch, the screw length, the head shape, and the like of these screws can be designed as desired in the same way as a general metal screw. The coupling member 41 may be composed of a carbon composite material, or a steel material or a Ni alloy material.

### (Other Coupling Means)

A third coupling means may have a configuration in which the lower portion of the support column 3 includes a lower engaging part that engages with the upper portion of another support column 3 via a coupling member (coupling screw, for example), and the upper portion of the support column 3 includes an upper engaging part (engaging projection) that directly engages with the engaging hole of the lower portion of another support column without a coupling member. Here, “via a coupling member” refers to a case where, similar to the first coupling means, a coupling screw is adopted, and “without a coupling member” refers to a case where, similar to the second coupling means, the support column 3 including the upper engaging part 51 (engaging projection) and the lower engaging part 52 (engaging hole) is adopted.

A fourth coupling means may have a configuration in which the lower portion of the support column 3 includes a lower engaging part (engaging hole) that directly engages with the engaging projection of the upper portion of another support column 3 without a coupling member, and the upper portion of the support column 3 includes an upper engaging part that engages with the lower portion of another support column 3 via another coupling member. Here, “without a coupling member” refers to a case where, similar to the second coupling means, the support column 3 including the upper engaging part 51 and the lower engaging part 52 is adopted, and “via a coupling member” refers to a case where, similar to the first coupling means, a coupling screw is adopted.

As described above, examples of the coupling means include the first to fourth coupling means. In these coupling means, when the coupling members 31, 41 to be coupled to the support column 3 in the first stage are made of a carbon composite material, preferably a sheet of a steel material or a Ni alloy material is arranged thereunder, or the coupling members 31, 41 are placed on a pan of a steel material or a Ni alloy material. Thus, it is possible to prevent wear of the coupling members 31, 41 that occurs during loading in and out of the heat treating furnace. Further, when a bottom surface of the base part 11 is in direct contact with a floor surface even if the coupling members 31, 41 in the first stage are engaged, it is possible to arrange a sheet or place the coupling members 31, 41 on a pan and prevent wear of the coupling members 31, 41 and the base part bottom surface that occurs during loading in and out of the heat treating furnace.

### <Part Receiver>

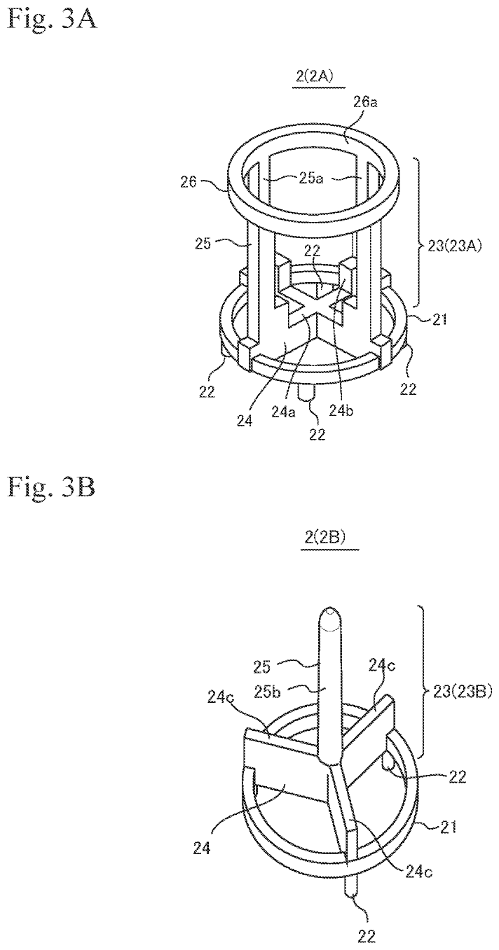

The part receiver 2, as illustrated in FIGS. 3A and 3B, includes a pedestal 21 that detachably comes into contact with the tray 1, a locking part 22 that is provided to the pedestal 21 and holds the pedestal 21 on the tray 1, and a part receiving section 23 that extends above the pedestal 21 or is located on the pedestal 21. The locking part 22 of this part receiver 2 is provided to the pedestal 21 that comes into contact with the tray 1, and thus the detachable part receiver 2 can be held as a separate member on the respective mounting part of the tray 1. As a result, even when the part receivers 2 can be prepared as spares and parts to be heat-treated having other shapes are to be simultaneously heat-treated, a plurality of types of the part receivers 2 to be mounted onto the tray 1 can be simultaneously mounted. As long as the part receiver 2 has a structural form that exhibits such an effect, the structure thereof is not limited to the shapes illustrated in FIGS. 3A and 3B. It should be noted that the part receivers 2 illustrated in FIGS. 3A and 3B each have a structural form including a frame-shaped receiving section 24 and a support column part 25.

The part receivers 2, as illustrated in FIGS. 3A and 3B, are each detachably mounted onto the tray 1, and are a member that places the parts to be heat-treated to heat-treat the parts to be heat-treated in a heat treating furnace. The part receivers 2 (2A, 2B), as illustrated in FIGS. 3A and 3B, may be formed in complex shapes, and desirably are formed with high dimensional accuracy. The reason that the part receiver 2 is formed with high dimensional accuracy is that portions where the part receiver 2 and the part to be heat-treated come into contact with each other tend to be insufficiently carburized, and the part receiver 2 having low dimensional accuracy may include many portions where the part receiver 2 and the part to be treated come into contact with each other, the parts coming into contact with each other, and the inability to satisfy the required quality in the carburization of the parts after heat treatment. Further, in order to heat-treat many parts to be heat-treated simultaneously or other types of parts to be heat-treated simultaneously, desirably many part receivers 2 are detachably mounted onto the tray 1. In that case, it is not favorable to unnecessarily widen the pitch and the gap between the part receivers 2. Rather, to efficiently heat-treat the parts to be heat-treated, it is necessary to heighten (increase) a mounting density of the part receivers 2. Accordingly, desirably the pitch and the gap between the part receivers 2 are narrowed, and therefore desirably the part receiver 2 is fabricated with high dimensional accuracy.

As the part receiver 2, a part receiver fabricated by a lost wax process described later is particularly preferable, and is excellent in terms of cost as well. The lost wax process makes it possible to carry out fabrication with high accuracy at low cost, even with a complex shape, and thus, for example, desirably the part receiver 2A or the like having a cylindrical shape illustrated in FIG. 3A, or the like is designed with high dimensional accuracy to ensure that the part to be heat-treated does not come into contact with a circular frame-shaped inner surface 26a and a support column part inner circumferential surface 25a. Thereby, the part to be heat-treated is placed on a placement surface 24a illustrated in FIG. 3A and may be fixed in position so as to not cause rattling at a side surface 24b provided as desired. In particular, the part receiver 2 fabricated by the lost wax process makes it possible to heat-treat a large number of parts to be heat-treated in one type or many types at once, even if the shapes are complex. Then, it is possible to improve a dimensional accuracy of the placement surface 24a and the side surface 24b, thus avoid contact between the part to be heat-treated and the part receiver 2A, perform the carburizing treatment uniformly, and manufacture high-quality carburized parts at low cost.

On the other hand, when the dimensional accuracy of the placement surface 24a and the side surface 24b constituting the frame-shaped receiving section 24 is low and the gap between the part receiver and the part to be heat-treated is large, the parts to be heat-treated incline, rattle, and come into contact with the circular frame-shaped inner surface 26a and the support column part inner circumferential surface 25a due to inclination, vibration, and the like during transfer of the tray 1. Such contact may make carburizing or the like insufficient, and the required quality in the carburization of parts after heat treatment may not be met.

From the above, according to the present invention, it is possible to avoid contact between the part to be heat-treated and the part receiver 2A, perform the carburizing treatment uniformly, and manufacture high quality carburized parts at low cost. On the other hand, with only a tray of a C/C composite (carbon composite material; hereinafter the same) as in Patent Documents 4 and 5, the part receiver is molded with a lattice-shaped C/C composite as in Patent Document 4 and, when the part to be heat-treated is in contact with the side surface of the lattice-shaped C/C composite, carbon is supplied from the contact part of the C/C composite, causing a quality problem in that excessive carburizing treatment is performed. Further, in Patent Document 5, although the parts to be heat-treated are placed in a box-shaped basket, there is no partition for preventing the parts to be heat-treated from coming into contact with each other and, in some cases, the parts to be heat-treated are placed so as to randomly overlap each other. The overlapping portion is problematic in terms of quality in that sufficient carburizing treatment is not performed. In contrast to this Patent Document 5, in the present invention, the part receiver 2 is detachably mounted as separate member onto the tray composed of a carbon composite material that is less susceptible to thermal deforming and distortion, thereby preventing the occurrence of bending and distortion in the tray 1, even when, for example, the part receiver 2B having the form illustrated in FIG. 3B is mounted onto the tray at a particularly narrow pitch, and thus the part receiver 2B does not incline. Furthermore, even when a part to be heat-treated having a circular shape (gear or the like) and formed with a round hole in an outer circumferential surface 25b of a rod-shaped support column part 25 of the part receiver 2B is placed on a placement surface 24c of the part receiver 2B, the part receiver 2 can be manufactured with high accuracy by the lost wax process. As a result, the dimensional accuracy of the rod-shaped support column part 25 of the part receiver 2B can be improved, a dimensional difference between the outer circumferential surface 25b of the rod-shaped support column part 25 and an inner diameter of the part to be heat-treated having a circular shape (gear or the like) can be properly controlled, and the part to be heat-treated having a circular shape (gear or the like) does not protrude from the placement surface 24c or the pedestal 21, making it possible to prevent adjacent parts to be heat-treated from coming into contact with each other. From the above, the present invention enables sufficient and uniform carburizing treatment of parts to be heat-treated, making it possible to satisfy the required quality of the parts.

While the manufacturing method of the part receiver 2 is not particularly limited, costs increase with a machining process such as cutting, and thus adoption of the lost wax process is particularly desirable. With the lost wax process thus adopted, complex and high-precision structural parts can be efficiently manufactured. The part receiver 2 fabricated by the lost wax process can be detachably mounted onto the tray 1 as a member separate from the tray 1, and thus, even if complex in shape or not insusceptible to deforming over an extended period of time due to heat treatment, can be immediately replaced with another spare part. It should be noted that the lost wax process is a method in which a prototype is formed of wax, a periphery of the prototype is covered and solidified with casting sand or plaster, the internal wax is melted and removed by heating, and a molten steel material is poured into the formed cavity to obtain a casting having the same shape as the prototype.

The material of the part receiver 2, while not particularly limited as long as a steel material or a Ni alloy, preferably may be a steel material or a Ni alloy that can be preferably manufactured by the lost wax process. Specific examples include a nickel-containing steel material such as austenitic stainless steel and a heat-resistant cast steel, and high-Ni alloys such as Inconel. These steel materials or Ni alloys are excellent in high-temperature strength and high-temperature oxidation resistance, and thus can be preferably adopted as members repeatedly loaded into a heat treating furnace. From the standpoint of heat resistance and thermal deforming prevention, the material may be a steel material or a Ni alloy containing various metal materials, or may be obtained by treating the part receiver 2 after machining and subsequently subjecting the result to a hardening treatment and a surface modifying treatment.

The part receiver 2, as illustrated in FIGS. 3A and 3B, includes the pedestal 21 that detachably comes into contact with the tray 1, the locking part 22 that is provided to the pedestal 21 and holds the pedestal 21 on the tray 1, and the part receiving section 23 that extends above the pedestal 21. In the part receiver 2, the locking part 22 is provided to the pedestal 21 that comes into contact with the tray 1, and thus the locking part 22 acts to hold the detachable part receiver 2 in a predetermined position of the tray 1. Even when such part receivers 2 may be prepared as spares and parts to be heat-treated having other shapes are to be simultaneously heat-treated, a plurality of types of the part receivers 2 to be mounted onto the tray 1 may be simultaneously mounted.

The pedestal 21 acts to detachably come into contact with and be placeable on the base part 11 of the tray 1. While a shape thereof is not particularly limited, when, for example, as illustrated in FIGS. 3A and 3B and FIG. 5, the base part 11 of the tray 1 is the mounting part 13 having a quadrangular shape, preferably the shape of the pedestal is circular and is formed into a size that allows the pedestal 21 having a circular shape to be placed on each side of the quadrangular shape of the mounting part 13.

The locking part 22 is provided to the pedestal 21 and acts to hold the pedestal 21 on the tray 1. A shape thereof, while not particularly limited, preferably has projecting parts provided at three or four locations below the pedestal 21 having a circular shape, as illustrated in FIGS. 3A and 3B and FIG. 5, for example. With this projecting part thus provided, the part receiver 2 mounted onto the mounting part 13 of the base part 11 can be held so as not to shift from that position. A shape, a quantity, a position, and the like of the projecting part can be designed as desired in response to the shape, the dimensions, and the like of the mounting part 13 and the like.

The part receiving section 23 extends above the pedestal 21, acts to place the part to be heat-treated, and is configured to include at least the frame-shaped receiving section 24 and the support column part 25, as illustrated in FIGS. 3A and 3B. A shape thereof, while not particularly limited, may be a desired shape illustrated in FIGS. 3A and 3B, for example. In particular, the part receiver 2 is a separate body from the tray 1 and individually formed, and thus, even if the shapes are complex, can conveniently be formed by the lost wax process or the like. Then, even when deforming accumulates or occurred cracking expands due to use over an extended period of time and replacement is desired, only the part receiver 2 for which replacement is desired may be replaced, making it possible to significantly decrease costs compared to when an integral structure is replaced in its entirety.

The frame-shaped receiving section 24 is a frame-shaped structural part on which a part to be heat-treated is placed, and is provided so as to extend across the pedestal 21 having a circular shape, with upper surfaces thereof serving as placement surfaces 24a, 24c, as illustrated in FIGS. 3A and 3B, for example. A shape thereof, while not particularly limited, preferably is a cross-linking form extending from four locations or three locations of the pedestal 21 having a circular shape toward the center, as illustrated in FIG. 3A. It should be noted that the side surface 24b in FIG. 3A acts to restrain the part to be heat-treated (a part to be heat-treated having a cylindrical shape, for example) placed on the placement surface 24a from all sides and fix a position thereof so that rattling does not occur.

The support column part 25 is provided so as to extend upward from the frame-shaped receiving section 24, for example. While a shape thereof is not particularly limited, the support column part 25 in FIG. 3A is constituted by four support columns extending upward from four locations of the pedestal 21 having a circular shape, and the support column part 25 in FIG. 3B is constituted by one support column extending upward from a center of the frame-shaped receiving section 24 extending from the pedestal 21 having a circular shape. It should be noted that the support column part 25 in FIG. 3B is a support column part 25 having a rod shape or a shape with a cross section thereof extending radially, and acts so that, with a part to be heat-treated having a circular shape (gear or the like) and formed with a round hole in a center thereof, the support column part 25 having a rod shape or a shape with a cross section thereof extending radially is inserted into the round hole, and the part to be heat-treated is placed on the placement surface 24c of the part receiver 2B.

An outer frame part 26, as in the structural form in FIG. 3A, acts to support the part to be heat-treated even in the unlikely event that the part to be heat-treated placed on the placement surface 24a topples over. A shape thereof, while not particularly limited, preferably is circular, as illustrated in FIG. 3A.

As described above, the heat-treatment tray member 10, even when repeatedly loaded into a heat treating furnace with parts placed thereon to heat-treat the parts, suppresses the occurrence of deforming and cracking, allowing use for an extended period of time. As illustrated in FIG. 4 and FIG. 6, it is possible to stack the trays 1 in multiple stages, and hook many parts to be heat-treated having a single form or a plurality of forms onto the part receivers 2 to simultaneously heat-treat the parts.

In this way, the heat-treatment tray member 10 in the first embodiment can be configured. In this heat-treatment tray member 10 in the first embodiment, the trays 1 coupled by the coupling means are stacked in multiple stages to obtain a heat-treatment stacked structure. It is possible to place the detachable part receivers 2 onto each of the trays 1, and place parts onto the part receivers 2 to load the member into a heat treating furnace. In the present invention, even when the tray member 10 is repeatedly loaded into a heat treating furnace with parts placed thereon to heat-treat the parts, it is possible to suppress the occurrence of deforming and cracking to ensure use for an extended period of time, and further perform sufficient and uniform carburizing treatment of the parts to be heat-treated.

### [Heat-Treatment Tray Member of Second Embodiment]

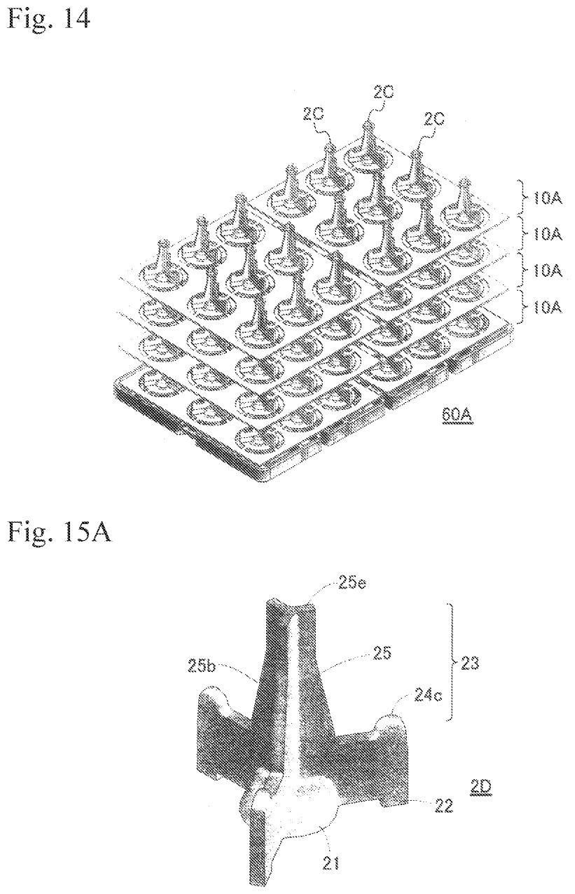

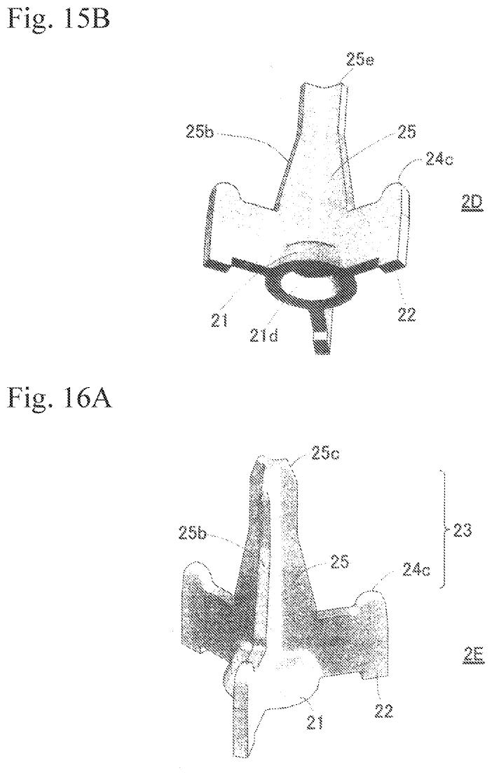

The heat-treatment tray member 10 in a second embodiment, as illustrated in FIGS. 15A and 15B, FIGS. 16A and 16B, and FIG. 17 to FIG. 19, differs from the heat-treatment tray member in the first embodiment that uses the support column 3 and the coupling members 31, 41 as coupling means in that the part receiver 2 and the tray 1 are combined to form tray members 10A, 10B. In the heat-treatment tray member 10 in the second embodiment, the tray members 10A, 10B are stacked in multiple stages to form heat-treatment stacked structures 60A, 60B illustrated in FIG. 14 and FIG. 19. With the heat-treatment stacked structures 60A, 60B, by layering the tray members 10A in multiple stages, it is possible to stack the trays 1, on which a large number of parts to be heat-treated can be placed, in a plurality of stages. It should be noted that, in the following, a coupling means for combining the part receiver 2 and the tray 1 will be described as fifth and sixth coupling means.

### <Fifth Coupling Means>

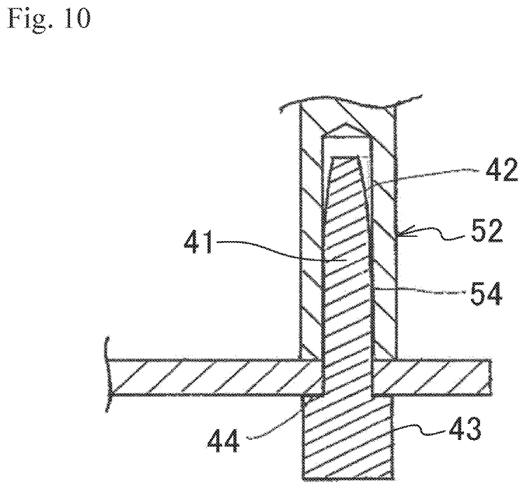

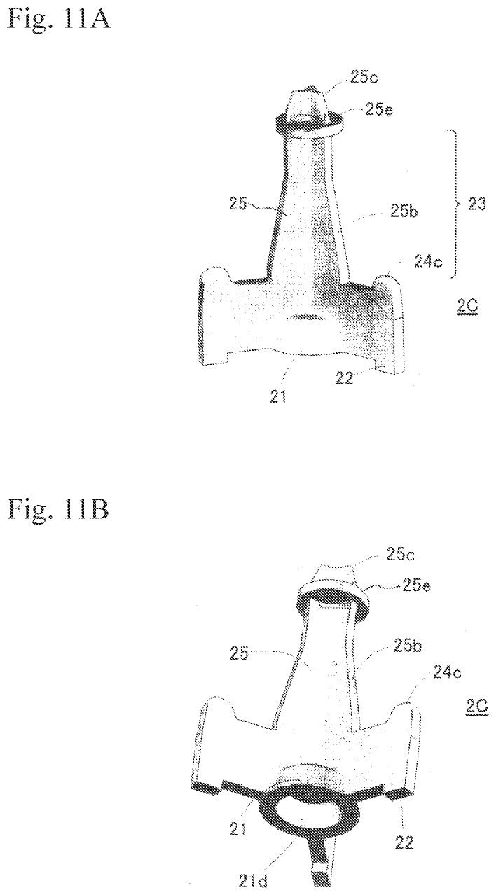

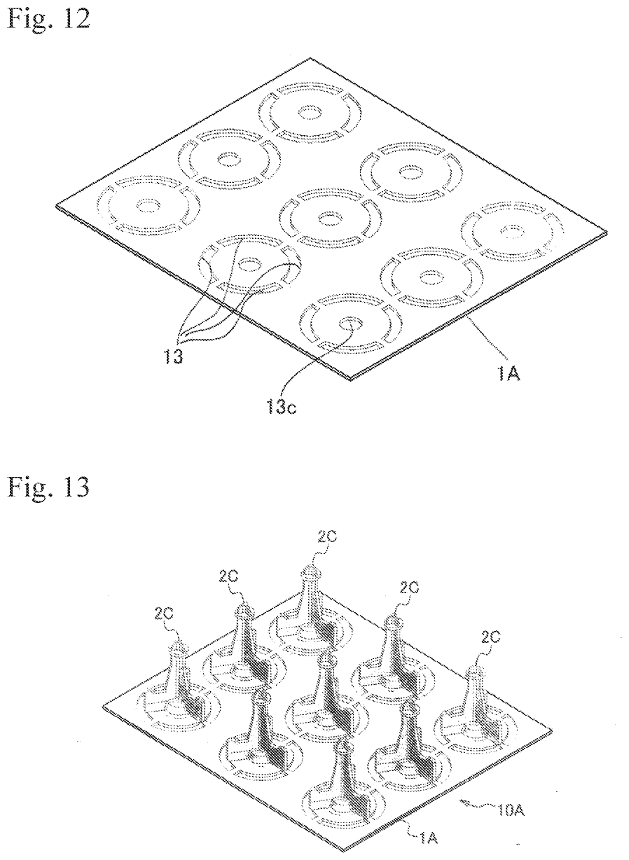

FIGS. 11A and 11B is an example of a part receiver 2C, FIG. 12 is an example of a tray 1A on which the part receiver 2C is placed, FIG. 13 is the heat-treatment tray member 10A with the part receivers 2C placed on the tray 1A, and FIG. 14 is the heat-treatment stacked structure 60A obtained by stacking the heat-treatment tray members 10A. With this fifth coupling means, the part receivers 2C and the tray 1A can be combined without using a support column to form the tray member 10A. With this coupling means, the part receivers 2C act as coupling members, and the tray 1A is interposed between the part receivers 2C arranged above and below to form the tray member 10A. Accordingly, while the “part receiver 2C” is denoted using the same reference numeral for part receivers constituting the tray members 10A in the upper stage and the lower stage as well, for the sake of clarity in the text, those in the upper stage are expressed as “part receiver 2C′,” “tray 1A′,” and the like, and those in the lower stage are expressed as “part receiver 2C″,” “tray 1A″,” and the like.

### (Part Receiver)

The part receiver 2C, as illustrated in FIGS. 11A and 11B, includes the pedestal 21 that detachably comes into contact with the tray 1A, the locking part 22 that is provided to the pedestal 21 and holds the pedestal 21 on the tray 1, and the part receiving section 23 that extends above the pedestal 21. In the part receiver 2C, the locking part 22 is provided to the pedestal 21 that comes into contact with the tray 1A, and thus acts to hold the detachable part receiver 2C in a predetermined position of the tray 1A. Even when such part receivers 2C may be prepared as spares and parts to be heat-treated having other shapes are to be simultaneously heat-treated, a plurality of types of the part receivers 2C to be mounted onto the tray 1A may be simultaneously mounted. This part receiver 2C, similar to the part receivers 2A, 2B in the first embodiment, is a separate body from the tray 1 and individually formed, and can conveniently be formed by the lost wax process or the like.

The pedestal 21 acts to detachably come into contact with and be placeable on the tray 1A. A shape thereof, while not particularly limited, preferably is a circular shape, as illustrated in FIGS. 11A and 11B, for example.

The locking part 22 is provided to the pedestal 21 and acts to hold the pedestal 21 on the tray 1. A shape thereof, while not particularly limited, as illustrated in FIGS. 11A and 11B, for example, preferably has a projecting part extending radially from the pedestal 21 having a circular shape in three directions. With this projecting part thus provided, the part receiver 2C mounted onto the mounting part 13 of the tray 1A can be held so as not to shift from that position. A shape, a quantity, a position, and the like of the projecting part can be designed as desired in response to the shape, the dimensions, and the like of the mounting part 13 and the like.

The part receiving section 23 extends above the pedestal 21, acts to place the part to be heat-treated, and is configured to include at least the placement surface 24c and the support column part 25 as illustrated in FIGS. 11A and 11B. A shape thereof, while not particularly limited, may be a desired shape illustrated in FIGS. 11A and 11B, for example. The placement surface 24c is a portion on which the part to be heat-treated is placed, and a shape thereof, while not particularly limited, is preferably provided in a position extending radially from the pedestal 21 having a circular shape in three directions, as illustrated in FIGS. 11A and 11B. The support column part 25 is provided so as to extend upward from the pedestal 21. While a shape thereof is not particularly limited, the support column part 25 in FIGS. 11A and 11B is constituted by rod-shaped support columns extending upward from four locations of the pedestal 21 having a circular shape. A cross section of the support column has a shape that includes the side surface 25b extending radially in three directions. A part to be heat-treated having a circular shape (gear or the like) and formed with a round hole in a center thereof is preferably mounted onto this part receiving section 23 and placed on the placement surface 24c of the part receiver 2B with the support column part 25 inserted into the round hole.

The part receiver 2C includes an upper engaging part (projection) 25c and a lower engaging part (hole part) 21d. The upper engaging part (projection) 25c engages with a lower engaging part (hole part) 21d′ of another part receiver 2C′ provided to a tray 1A′ in an upper stage, and couples the part receiver 2C and the tray 1A′ in the upper stage. The upper engaging part (projection) 25c includes a shoulder part 25e for placing and supporting the other tray 1A′ in the upper stage. A height and a shape of the projection, which is the upper engaging part 25c is not particularly limited, but preferably a depth size thereof is about the same as or smaller than that of the hole part, which is the lower engaging part 21d, and preferably a shape thereof is tapered, becoming slightly thinner toward the end, as illustrated in FIGS. 11A and 11B. The shoulder part 25e, as illustrated in FIGS. 11A and 11B, constitutes a portion of the upper engaging part (projection) 25c and, when the upper engaging part (projection) 25c is inserted into a through hole 13c of the tray 1A, is an area that acts to support and hold the tray 1A. Accordingly, the shoulder part 25e may have a circular flange shape as illustrated in FIGS. 11A and 11B.

The lower engaging part (hole part) 21d engages with an upper engaging part (projection) 21d″ of another part receiver 2C″ provided to a tray 1A″ in a lower stage, and couples the part receiver 2C and the tray 1A″ in the lower stage. The lower engaging part (hole part) 21d is a recessed hole, and a depth and a size thereof is not particularly limited, but preferably a projection size thereof is about the same as or greater than that of the upper engaging part 25c, and preferably a shape thereof is tapered hole, becoming slightly thinner toward the back of the hole, as illustrated in FIGS. 11A and 11B.

A dimensional accuracy of such a part receiver 2C is high, making it possible to increase the mounting density. As a result, adjacent parts to be heat-treated do not come into contact with each other, and carburizing defects at contacting locations do not occur. It should be noted that the part to be heat-treated may come into contact with the placement surface 24c and the side surface 25b, but it is assumed that the contacting location is not a place that affects the quality of the carburization.

### (Tray)

The tray 1A, similar to the tray 1 in the above-described first embodiment, is provided separately from the part receiver 2C, and is formed of a carbon composite material. The tray 1A is a member including a plurality of the mounting parts 13 capable of mounting the part receivers 2C in predetermined positions. The through hole 13c is provided to all mounting parts 13. The projection 25c of the part receiver 2C″ in the lower stage is inserted into the through hole 13c, engages with the hole part 21d of the part receiver 2C, and is positioned. On the other hand, the tray 1A does not include attaching holes for the corner support columns and the center support columns provided to the tray 1 in the above-described first embodiment. Accordingly, the stacking of the tray 1 is not performed by utilizing the corner support columns or the center support columns, but by engaging and combining the part receiver 2C and the tray 1A using the through holes 13c provided to all mounting parts 13.

The part receiver 2C mounted onto the mounting part 13 of the tray 1A is positioned and held so as not to shift from that position. A shape of the mounting part 13, a size and a position of the through hole 13c, and the like can be designed as desired in response to a shape, dimensions, and the like of the part receiver 2C. The part receiver 2C is placed on the tray 1A to form the heat-treatment tray member 10A illustrated in FIG. 13, and the heat-treatment tray members 10A are stacked to form the heat-treatment stacked structure 60A illustrated in FIG. 14.

### (Heat-Treatment Stacked Structure)

The heat-treatment stacked structure 60A, as illustrated in FIG. 14, is obtained by stacking the heat-treatment tray members 10A. In the stacking, first, a base member 4 described later is used as a member in the lowermost stage, and the heat-treatment tray member 10A illustrated in FIG. 13 is placed thereon as the tray member in the first stage. Next, the heat-treatment tray member 10A in the second stage is placed, and those in the third and subsequent stages are further placed. In this way, the heat-treatment stacked structure 60A with the tray members 10A stacked in multiple stages is obtained. It should be noted that, in the multi-stage stacking procedure, the heat-treatment tray members 10A illustrated in FIG. 13 that have been prepared in advance may be sequentially layered, or may be sequentially stacked by placing the tray 1A on the base member 4, placing the part receivers 2C side by side on the mounting parts 13 of the tray 1A, subsequently placing the tray 1A′, and further placing the part receivers 2C′ side by side on a mounting parts 13′ of the tray 1A′.

### <Base Member>

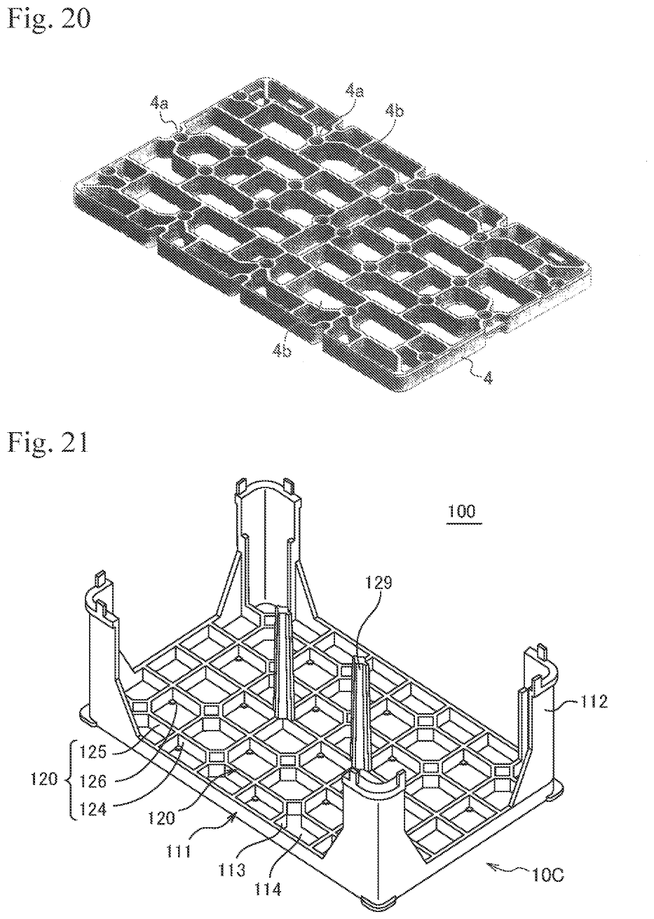

The heat-treatment stacked structure 60A described above is obtained by stacking a plurality of the heat-treatment tray members 10A and is repeatedly loaded into a heat treating furnace along with parts to be heat-treated. In this heat-treatment stacked structure 60A, the base member 4 illustrated in FIG. 20 may be preferably adopted as the heat-treatment tray member in the first stage. This base member 4 is preferably constituted by a steel material or a Ni alloy material. Further, the heat-treatment tray members in the second and subsequent stages are the above-described heat-treatment tray members 10A. The base member 4 can prevent wear of a lower surface part of the heat-treatment tray member 10A that occurs during loading in and out of the heat treating furnace.

In the example in FIG. 20, the base member 4 includes reinforcement holes 4a and space parts 4b. The reinforcement holes 4a, by being provided as circular holes to intersecting parts of the frame, are provided so as to increase a rigidity and the like of the entire base member. The space parts 4b are provided as desired as needed in order to save the weight. It should be noted that the base member 4 is the same as that described as “pan” in the explanatory section of the coupling means. It should be noted that the heat-treatment tray member 10 in the first embodiment described above according to the present invention may be stacked on this base member 4.

### <Sixth Coupling Means>

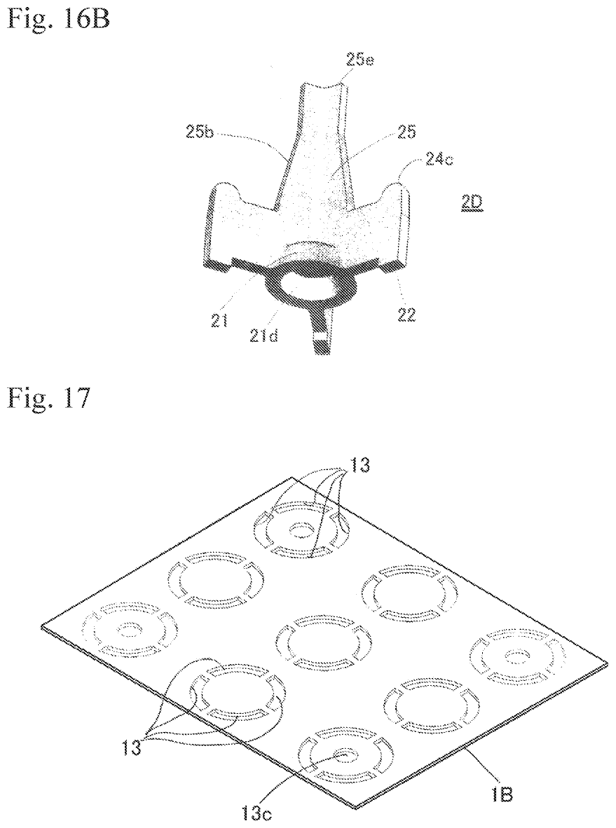

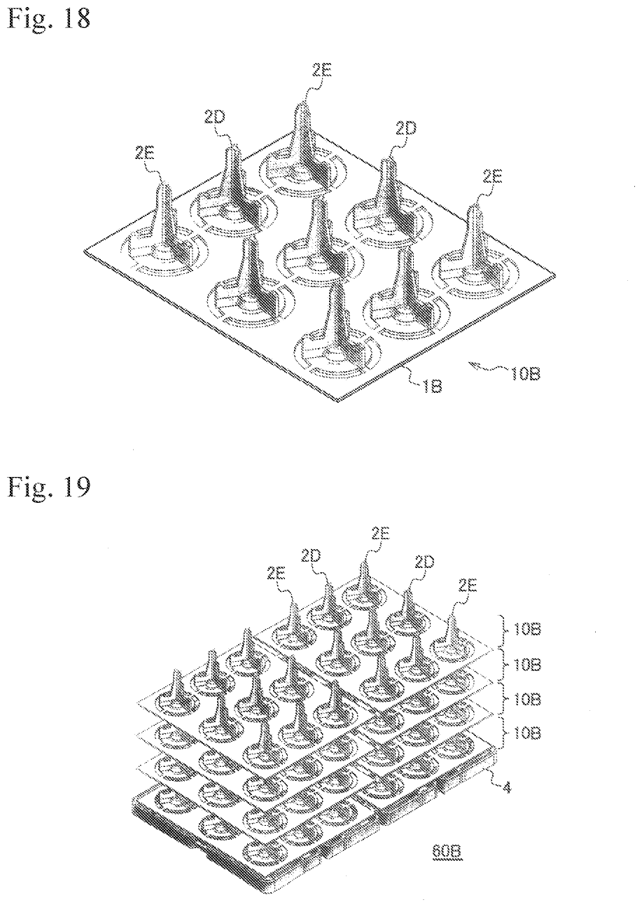

FIGS. 15A and 15B and FIGS. 16A and 16B are examples of part receivers 2D, 2E, FIG. 17 is an example of a tray 1B on which the part receivers 2D, 2E are placed, FIG. 18 is the heat-treatment tray member 10B with the part receivers 2D, 2E placed on the tray 1B, and FIG. 19 is the heat-treatment stacked structure 60B obtained by stacking the heat-treatment tray members 10B. With this sixth coupling means, the two types of the part receivers 2D, 2E and the tray 1B can be combined to form the tray member 10B. With this sixth coupling means, the part receivers 2D, 2E act as coupling members, and the tray 1B is interposed between the two types of the part receivers 2D, 2E arranged above and below to form the tray member 10B. Accordingly, while the “part receivers 2D, 2E” are denoted using the same reference numerals for part receivers constituting the tray members 10B in the upper stage and the lower stage as well, for the sake of clarity in the text, those in the upper stage are expressed as “part receiver 2D′,” “part receiver 2E′,” “tray 1B′,” and the like, and those in the lower stage are expressed as “part receiver 2D″,” “part receiver 2E″,” “tray 1B″,” and the like.

### (Part Receiver)

The part receivers 2D, 2E, as illustrated in FIGS. 15A and 15B and FIGS. 16A and 16B, each include the pedestal 21 that detachably comes into contact with the tray 1A, the locking part 22 that is provided to the pedestal 21 and holds the pedestal 21 on the tray 1, and the part receiving section 23 that extends above the pedestal 21. The pedestal 21, the locking part 22, and the part receiving section 23 have the same structural form as the part receiver 2C described using the fifth coupling means, and thus a description thereof is omitted.

The part receiver 2D illustrated in FIGS. 15A and 15B does not engage with the lower engaging part 21d′ of another part receiver 2D′ provided to a tray 1B′ in an upper stage and includes, in an upper portion thereof, only the shoulder part 25e that places and holds the tray 1B′ in the upper stage, and includes, in a lower portion thereof, the hole part 21d that may or may not engage with the upper portion of another part receiver 2D″ provided to a tray 1B″ in a lower stage. That is, the upper portion of the part receiver 2D is not provided with the projection 25c of the part receiver 2C illustrated in FIGS. 11A and 11B, but is provided with the shoulder part 25e only. With this part receiver 2D, when the tray 1B′ is provided on the part receiver 2D, the shoulder part 25e abuts the tray 1B′ from below and acts to support the tray 1B′. Accordingly, preferably a height from a lower end portion of the pedestal 21 to an upper end portion of the shoulder part 25e is the same as a height pitch of the tray member 10B. The lower portion of the part receiver 2D is provided with the same hole part 21d as the part receiver 2C illustrated in FIGS. 11A and 11B. The form of this hole part is the same as that of the part receiver 2C in FIGS. 11A and 11B.

The part receiver 2E illustrated in FIGS. 16A and 16B includes, in an upper portion thereof, the projection 25c that engages with the lower engaging part 21d′ of another part receiver 2E′ provided to the tray 1B′ in the upper stage and includes, in a lower portion thereof, the hole part 21d that engages with a projection 25c″ of another part receiver 2E″ provided to the tray 1B″ in the lower stage, that is, the upper portion of the part receiver 2E is not provided with the shoulder part 25e provided to the part receiver 2C illustrated in FIGS. 11A and 11B, but is provided with the projection 25c only. With this part receiver 2E, when the tray 1B′ is provided on the part receiver 2E, the projection 25c passes through a through hole 13c′ of the tray 1B′, and acts to engage with the hole part 21d′ of the lower portion of the part receiver 2E′ positioned in the upper stage. The form of the projection 25c is the same as that of the part receiver 2C in FIGS. 11A and 11B. The lower portion of the part receiver 2E is provided with the same hole part 21d as the part receiver 2C illustrated in FIGS. 11A and 11B. The form of this hole part is the same as that of the part receiver 2C in FIGS. 11A and 11B.

While, with this sixth coupling means, the two types of the part receiver 2D and the part receiver 2E are combined to form the tray member 10B illustrated in FIG. 18, other part receivers instead of the part receiver 2D and the part receiver 2E or partially changed in structure may be used.

As a modification, for example, the part receiver 2D described above may have a form in which the hole part 21d of the lower portion is not provided. Specifically, the part receiver 2D may have a form that does not engage with the lower engaging part 21d′ of the other part receiver 2D′ provided to the tray 1B′ in the upper stage and includes, in an upper portion thereof, only the shoulder part 25e that simply places and holds the tray 1B′ in the upper stage, and does not include, in a lower portion thereof, the hole part 21d that may or may not engage with the upper portion of the other part receiver 2D″ provided to the tray 1B″ in the lower stage.

As another modification, for example, the part receiver 2E described above may have a form in which the hole part 21d of the lower portion is not provided. Specifically, the part receiver 2E may have a form that includes, in an upper portion thereof, the projection 25c that engages with the lower engaging part 21d′ of the other part receiver 2E provided to the tray 1B′ in the upper stage, and does not include, in a lower portion thereof, the hole part 21d that engages with the projection 25c″ of the other part receiver 2E″ provided to the tray 1B″ in the lower stage.

Such modifications may be selected as desired and used in combination with the part receiver 2D or the part receiver 2E, or may be used in place of the part receiver 2D or the part receiver 2E, as desired.

A dimensional accuracy of such the part receivers 2D, 2E is high, making it possible to increase the mounting density. As a result, adjacent parts to be heat-treated do not come into contact with each other, and carburizing defects at contacting locations do not occur. It should be noted that the part to be heat-treated may come into contact with the placement surface 24c and the side surface 25b, but it is assumed that the contacting location is not a place that affects the quality of the carburization.

### (Tray)

The tray 1B, similar to the tray 1A in the above-described second embodiment, is provided separately from the part receivers 2D, 2E, and the like, and is formed of a carbon composite material. The tray 1B is a member including a plurality of the mounting parts 13 capable of mounting the part receivers 2D, 2E in predetermined positions. In this tray 1B, the through holes 13c are not provided in all mounting parts 13 as in the above-described tray 1A and, in the example illustrated in FIG. 17, are provided only in the mounting parts 13 at the corners of the tray 1B. The positions where the through holes 13c are formed is not limited to the mounting parts 13 at the corners only, and may be provided in desired positions as needed. For example, the through hole 13c may be provided in the mounting part 13 at or near the center of the tray 1B, or in the mounting parts 13 on the sides of the tray 1B. The projection 25c of the part receiver 2E″ in the lower stage is inserted into this through hole 13c, engages with the hole part 21d of the part receiver 2D or the part receiver 2E, and is positioned. Accordingly, by arranging the through holes 13c regularly, it is possible to stably layer the trays 1B, and form a stable heat-treatment tray member 10B. It should be noted that the tray 1B does not include the attaching parts 16, 18 for the corner support columns and the center support columns as in the tray 1 in the above-described first embodiment.

Similar to the case of the tray 1A, the part receivers 2D, 2E mounted onto the mounting parts 13 of the tray 1B are held so as not to shift from those positions. The shape of the mounting part 13, the quantity, the size, and the position of the through hole 13c, and the like can be designed as desired in response to a shape, dimensions, and the like of the part receivers 2D, 2E. The part receivers 2D, 2E are placed on the tray 1B to form the heat-treatment tray member 10B illustrated in FIG. 18, and the heat-treatment tray members 10B are stacked to form the heat-treatment stacked structure 60B illustrated in FIG. 19.

### (Heat-Treatment Stacked Structure)

The heat-treatment stacked structure 60B, as illustrated in FIG. 19, is obtained by stacking the heat-treatment tray members 10B. In the stacking, first, the base member 4 described later is used as the member in the lowermost stage, and the heat-treatment tray member 10B illustrated in FIG. 18 is placed thereon as the tray member in the first stage. Next, the heat-treatment tray member 10B in the second stage is placed, and those in the third and subsequent stages are further placed. In this way, the heat-treatment stacked structure 60B with the tray members 10B stacked in multiple stages is obtained. It should be noted that, in the multi-stage stacking procedure, the heat-treatment tray members 10B illustrated in FIG. 18 that have been prepared in advance may be sequentially layered, or may be sequentially stacked by placing the tray 1B on the base member 4, placing the two types of the part receivers 2D, 2E side by side on the mounting parts 13 of the tray 1B, subsequently placing the tray 1B′, and further placing the part receivers 2D′, 2E′ side by side on the mounting parts 13′ of the tray 1B′.

### <Base Member>

The base member 4 is the same as the content described in the explanatory section of the above-described heat-treatment stacked structure 60A, and thus a description thereof is omitted here.

### [Heat-Treatment Stacked Structure of Third Embodiment]

The heat-treatment stacked structure in a third embodiment is a heat-treatment stacked structure obtained by stacking a plurality of the heat-treatment tray members in each embodiment described above, and is repeatedly loaded into a heat treating furnace along with parts to be heat-treated. Then, a heat-treatment tray member 10C in the first stage, as illustrated in FIG. 21, includes the base part 111, the corner support column 112, the center support column 129, and a plurality of part receivers, the corner support column 112 and the center support column 129 being integrally constituted with the base part 111 by a steel material or a Ni alloy material, and the part receivers being detachably mounted onto the base part 111. While not illustrated in FIG. 21, the detachable part receiver is actually selected from the part receivers 2A to 2E mentioned above. As the heat-treatment tray members in the second and subsequent stages, the heat-treatment tray members 10, 10A, 10B in the first and second embodiments described above according to the present invention can be utilized.

The heat-treatment tray members 10, 10A, 10B in the first and second embodiments utilized as the heat-treatment tray members in the second and subsequent stages are stably supported by the four corner support columns 112 of the tray member 10C in a lowermost stage, and are supported in a reinforced manner by the center support column 129 as well. As a result, many parts to be heat-treated having a single form or a plurality of forms can be placed on the part receivers and simultaneously heat-treated. Further, the tray member 10C in the first stage is formed of a steel material or a Ni alloy material, and thus is inferior in heat resistance and thermal deformation compared to a carbon composite material. However, the tray member 10C, because the material thereof is less expensive than a carbon composite material, may be replaced when use is no longer possible due to thermal deforming or the like. Further, while a tray made of a carbon composite material, when used in the first stage, wears due to friction with the floor surface during loading in and out of the heat treating furnace, the first stage is formed of a steel material or a Ni alloy material, and therefore such problems do not also exist.

### [Heat-Treatment Stacked Structure of Fourth Embodiment]

The heat-treatment stacked structure in a fourth embodiment is a heat-treatment stacked structure obtained by stacking a plurality of the heat-treatment tray members in each embodiment described above, and repeatedly loaded into a heat treating furnace along with parts to be heat-treated. Then, as a heat-treatment tray member 10D in the first stage, a tray member exemplified as the conventional example illustrated in FIG. 22 can be utilized. The heat-treatment tray member 10D of the conventional example illustrated in FIG. 22 includes the base part 111, the corner support column 112, the center support column 129, and the part receiver 120, the corner support column 112 and the center support column 129 being integrally constituted with the base part 111 and the part receiver 120 by a steel material or a Ni alloy material. As the heat-treatment tray members in the second and subsequent stages, the heat-treatment tray members 10, 10A, 10B described in either the first or second embodiments described above according to the present invention can be utilized.

The heat-treatment tray members 10, 10A, 10B in the first and second embodiments utilized as the heat-treatment tray members in the second and subsequent stages are stably supported by the four corner support columns 112 of the tray member 10D in the lowermost stage, and are supported in a reinforced manner by the center support column 129 as well. With such support, it is possible to utilize the heat-treatment tray member of the conventional example that has been utilized to date. As a result, many parts to be heat-treated having a single form or a plurality of forms can be placed on the part receivers and simultaneously heat-treated. Further, the conventional tray member 10D in the first stage is formed of a steel material or a Ni alloy material, and thus is inferior in heat resistance and thermal deformation compared to a carbon composite material. However, the tray member 10D, because the material thereof is less expensive than a carbon composite material, may be replaced when use is no longer possible due to thermal deforming or the like. Furthermore, while a tray made of a carbon composite material, when used in the first stage, wears due to friction with the floor surface during loading in and out of the heat treating furnace, the first stage is formed of a steel material or a Ni alloy material, and therefore such problems do not also exist.

### EXAMPLES

The heat-treatment tray member 10 according to the present invention (Example 1) and a conventional cast steel product (Comparative Example 1) were compared in terms of the number of heat treating batches.

### Example 1

The heat-treatment tray member 10 according to the present invention and having the form illustrated in FIG. 1 was designated as Example 1. This heat-treatment tray member 10 was formed by machining a carbon composite material, and the base part 11, the corner support column 12, and the center support column 17 were all constituted by the carbon composite material. On the other hand, the part receiver 2 was composed of a cast steel material having a composition consisting of SCH13 (material symbol specified in “JIS G 5122 Heat-resistant steel and heat-resistant alloy castings”; hereinafter the same), and was obtained by the lost wax process. The dimensions of the tray member 10 were 500 mm in length, 600 mm in width, and 60 mm in height.

### Comparative Example 1

The conventional cast steel product illustrated in FIG. 13 was designated as Comparative Example 1. This cast steel product was composed of a cast steel material having a composition entirely consisting of SCH13, and obtained by the lost wax process. The dimensions were the same 500 mm in length, 600 mm in width, and 60 mm in height as those in Example 1, but the weight was 30 kg. This carbonizing furnace tray member 100, which is a cast steel product in this Comparative Example 1 is an integral structure member constituted by the base part 111 having a quadrilateral shape, the plurality of part receivers 120 arranged on the base part 111, the corner support columns 112 provided to each corner of the base part 111, and the center support column 129 provided near the center of the base part 111.

### [Test Method and Results]

A test was performed when each member of Example 1 and Comparative Example 1 was carburized in a carburizing furnace at a temperature of 980° C. The member most greatly affected by carburizing treatment is the base part of the tray, and therefore only the base part of the tray was evaluated. In the evaluation, the presence or absence of cracking and the presence or absence of deforming were visually evaluated. The results are shown in Table 1. In Table 1, “◯” indicates “no cracking and no deforming,” “Δ” indicates “no cracking and deforming without operational problems,” and “x” indicates “cracking or significant deforming not allowing operation.” From the results in Table 1, a difference between the two occurred when the number of heat treating batches exceeded 100, and a significant difference was confirmed when the number of heat treating batches was 200. In Comparative Example 1, the test was not performed more than 500 times. In Example 1, no cracking occurred and no deforming occurred even after 1500 batches.

### [Table 1]

TABLE 1

| | Number of Heat Treating Batches (Times) | | | | | |
|---|---|---|---|---|---|---|
| | 50 | 100 | 200 | 500 | 1000 | 1500 |
| Example 1 | ∘ | ∘ | ∘ | ∘ | ∘ | ∘ |
| Comparative | ∘ | Δ | x | — | — | — |
| Example 1 | | | | | | |

### DESCRIPTIONS OF REFERENCE NUMERALS

1, 1A, 1B Tray
2, 2A, 2B, 2C, 2D, 2E Part receiver
3 Support column (Corner support column, center support column, side support column)
4 Base member
4a Reinforcement hole
4b Space part
10, 10A, 10B, 10C, 10D Heat-treatment tray member
11 Base part
12 Corner support column
12a Support column lower portion
12b Support column upper portion
12c Engaging part (Screw hole)
12d Engaging part (Insertion hole)
13 Mounting part
13a Vertical frame in lattice-shaped mounting part
13b Horizontal frame in lattice-shaped mounting part
13c Though hole
14 Space
15 Corner
16 Corner support column attaching part (attaching hole)
17 Center support column
18 Center support column attaching part (attaching hole)
19 Weight saving hole
21 Pedestal
21d Lower engaging part (Hole part)
22 Locking part (Locking projection)
23 Part receiving section
24 Frame-shaped receiving section
24a Placement surface
24b Side surface
24c Placement surface
25 Support column part
25a Circular frame-shaped support column part inner circumferential surface
25b Rod-shaped support column part outer circumferential surface (side surface)
25c Upper engaging part (Projection)
25e Shoulder part
26 Outer frame part
26a Frame part inner circumferential surface
31 Coupling member (Coupling screw)
32 Lower engaging part (Cylindrical part)
33 Upper engaging part (Screw part)
41 Coupling member (not constituted by coupling screw)
42 Upper engaging part
43 Head part
44 Shoulder part (Base part receiving section)
51 Support column upper portion
52 Support column lower portion
53 Upper engaging part (Projection)
54 Lower engaging part (Engaging hole)
55 Support column shoulder part (Base part receiving section)
60A, 60B Heat-treatment stacked structure
100 Carburizing furnace tray member (with base part, part receiver, and support column integrated)
111 Base part
112 Corner support column
113 Frame wall
114 Space
120 Part receiver
124 Frame-shaped receiving section
125 Support column part
126 Outer frame part
129 Center support column

1. A heat-treatment tray member repeatedly loaded into a heat treating furnace along with parts to be heat-treated, comprising:
a tray; and
a plurality of part receivers detachably mounted onto the tray,
the tray including a base part provided with a plurality of mounting parts capable of mounting the plurality of part receivers in predetermined positions,
the base part being constituted by a carbon composite material, and
the plurality of part receivers being constituted by a steel material or a nickel alloy material.

2. The heat-treatment tray member according to claim 1, wherein
each of the plurality of mounting parts has a frame structure constituted by a frame and a space surrounded by the frame, and
the frame structure is selected from a circle, an ellipse, a triangle, a quadrangle, a honeycomb shape, and shapes similar thereto.

3. The heat-treatment tray member according to claim 1, wherein
the base part is provided with a corner support column at each corner thereof, and
the corner support column is constituted by a carbon composite material.

4. The heat-treatment tray member according to claim 3, wherein
the base part is provided with one or two or more center support columns at or near a center thereof, and
the one or two or more center support columns are constituted by a carbon composite material.

5. The heat-treatment tray member according to claim 1, wherein
the base part is provided with a corner support column at each corner thereof, and
the corner support column is constituted by a steel material or a nickel alloy material.

6. The heat-treatment tray member according to claim 5, wherein
the base part is provided with one or two or more center support columns at or near a center thereof, and
the one or two or more center support columns are constituted by a steel material or a nickel alloy material.

7. The heat-treatment tray member according to claim 3 wherein,
when a plurality of the trays are to be stacked, one of the following is selected:
(a) the corner support columns and the one or two or more center support columns each include, at a lower portion thereof, a lower engaging part that engages with an upper portion of another support column and couples to the base part via a coupling member, and, at an upper portion thereof, an upper engaging part that engages with a lower portion of another support column and couples to another tray to be stacked in an upper stage via another coupling member,
(b) the corner support columns and the one or two or more center support columns each include, at a lower portion thereof, a lower engaging part that engages with an upper portion of another support column and couples to the base part via a coupling member, and, at an upper portion thereof, an upper engaging part that directly engages with a lower portion of another support column and couples to another tray to be stacked in an upper stage without a coupling member,
(c) the corner support columns and the one or two or more center support columns each include, at a lower portion thereof, a lower engaging part that directly engages with an upper portion of another support column and couples to the base part without a coupling member, and, at an upper portion thereof, an upper engaging part that engages with a lower portion of another support column and couples to another tray to be stacked in an upper stage via another coupling member, and
(d) the corner support columns and the one or two or more center support columns each include, at a lower portion thereof, a lower engaging part that directly engages with an upper portion of another support column and couples to the base part without a coupling member, and, at an upper portion thereof, an upper engaging part that directly engages with a lower portion of another support column and couples to another tray to be stacked in an upper stage without a coupling member.

8. The heat-treatment tray member according to claim 7, wherein
when a plurality of the trays are to be stacked,
the corner support columns and the one or two or more center support columns each include an upper engaging part that engages with an engaging part of a lower portion of another support column in an upper stage and couples to another tray in an upper stage, and a lower engaging part that engages with an engaging part of an upper portion of another support column in a lower stage and couples to another tray in a lower stage, and
the upper engaging part is formed with a shoulder part that places and engages with another tray in an upper stage.

9. The heat-treatment tray member according to claim 7, wherein
when a plurality of the trays are to be stacked,
the coupling member includes an upper engaging part that engages with an engaging part of a support column lower portion and couples the support column and the tray, and a lower engaging part that engages with an engaging part of another support column upper portion in a lower stage and couples the support column and another tray in a lower stage.

10. The heat-treatment tray member according to claim 8, wherein
when a plurality of the trays are to be stacked,
a lower engaging part that couples the base part and a lower portion of the support column in a first stage is coupled by the coupling member, and
an engaging part that couples to another tray to be stacked in a second stage is coupled by the upper engaging part of a support column in the first stage and the lower engaging part of a support column in the second stage.

11. The heat-treatment tray member according to claim 1, wherein
each of the plurality of part receivers includes a pedestal that detachably comes into contact with the tray, a locking part that is provided to the pedestal and holds the pedestal on the tray, and a part receiving section that extends above the pedestal or a part receiving section that is located on the pedestal.

12. The heat-treatment tray member according to claim 11, wherein
the part receiving section includes a frame-shaped receiving section and a support column part.

13. The heat-treatment tray member according to claim 12, wherein
when a plurality of the trays are to be stacked,
each of the plurality of part receivers includes an upper engaging part that engages with a lower engaging part of another part receiver provided to a tray in an upper stage and couples the part receiver and the tray in the upper stage, and a lower engaging part that engages with an upper engaging part of another part receiver provided to a tray in a lower stage and couples the part receiver and the tray in the lower stage, and
the upper engaging part includes a shoulder part that places and supports the other tray in the upper stage.

14. The heat-treatment tray member according to claim 12, wherein,
when a plurality of the trays are to be stacked, each of the plurality of part receivers is selected from the following:
(a) a part receiver that includes, in an upper portion thereof, a shoulder part that places and holds a tray in an upper stage without engaging with a lower engaging part of another part receiver provided to the tray in the upper stage, and, in a lower portion thereof, a hole part that may or may not engage with an upper portion of another part receiver provided to a tray in a lower stage,
(b) a part receiver that includes, in an upper portion thereof, a projection that engages with a lower engaging part of another part receiver provided to a tray in an upper stage and, in a lower portion thereof, a hole part that engages with a projection of another part receiver provided to a tray in a lower stage,
(c) a part receiver that includes a shoulder part that only places and holds a tray in an upper stage without engaging with a lower engaging part of another part receiver provided to the tray in the upper stage, and a locking part that locks an upper engaging part of another part receiver provided to a tray in a lower stage, and
(d) a part receiver that includes only an upper engaging part that engages with a lower engaging part of another part receiver provided to a tray in an upper stage and does not include a locking part that locks an upper engaging part of another part receiver provided to a tray in a lower stage.

15. The heat-treatment tray member according to claim 1, wherein
the plurality of part receivers are fabricated by a lost wax process.

16. A heat-treatment stacked structure obtained by stacking a plurality of heat-treatment tray members and repeatedly loaded into a heat treating furnace along with parts to be heat-treated,
the heat-treatment tray member in a first stage being a base member constituted by a steel material or a nickel alloy material, and
the heat-treatment tray member in a second or subsequent stage being the heat-treatment tray member described in claim 11.

17. A heat-treatment stacked structure obtained by stacking a plurality of heat-treatment tray members and repeatedly loaded into a heat treating furnace along with parts to be heat-treated,
the heat-treatment tray member in a first stage including a base part, a corner support column, a center support column, and a plurality of part receivers, the corner support column and the center support column being integrally constituted with the base part by a steel material or a nickel alloy material, and the part receivers being detachably mounted onto the base part, and
the heat-treatment tray member in a second or subsequent stage being the heat-treatment tray member described in claim 11.

18. A heat-treatment stacked structure obtained by stacking a plurality of heat-treatment tray members and repeatedly loaded into a heat treating furnace along with parts to be heat-treated,
the heat-treatment tray member in a first stage including a base part, a corner support column, a center support column, and a part receiver, the corner support column and the center support column being integrally constituted with the base part and the part receiver by a steel material or a nickel alloy material, and
the heat-treatment tray member in a second or subsequent stage being the heat-treatment tray member described in claim 11.

19. The heat-treatment tray member according to claim 2, wherein
the base part is provided with a corner support column at each corner thereof, and
the corner support column is constituted by a carbon composite material.

20. The heat-treatment tray member according to claim 2, wherein
the base part is provided with a corner support column at each corner thereof, and
the corner support column is constituted by a steel material or a nickel alloy material.
